(19) United States
(12) Patent Application Publication
(10) Pub. No.: US 2025/0384819 A1
(43) Pub. Date: Dec. 18, 2025

(54) DISPLAY APPARATUS AND ELECTRONIC APPARATUS

(71) Applicant: Samsung Display Co., Ltd., Yongin-si (KR)

(72) Inventors: Eseudeo Yun, Yongin-si (KR); NACKHYEON KEUM, Yongin-si (KR); KYUNG-HOON KIM, Yongin-si (KR); Sanghun Kim, Yongin-si (KR); Yongchan Kim, Yongin-si (KR)

(21) Appl. No.: 19/176,944

(22) Filed: Apr. 11, 2025

(30) Foreign Application Priority Data
Jun. 13, 2024 (KR) 10-2024-0076742

(51) Int. Cl. G09G 3/32

(52) U.S. Cl. CPC G09G 3/32; G09G 2300/0819; G09G 2300/0842; G09G 2300/0861; G09G 2310/0286; G09G 2330/021

(57) ABSTRACT

A display apparatus may include a display panel including a pixel, a gate driver configured to output gate signals to the display panel, and including a first gate stage group for generating a first gate signals, and including a first gate odd stage group on a first side of the display panel, and a first gate even stage group on a second side of the display panel, and a second gate stage group for generating a second gate signals, and including a second gate odd stage group on the second side, and a second gate even stage group on the first side, and a data driver configured to apply a data voltage to the display panel.

### CROSS-REFERENCE TO RELATED APPLICATION

The present application claims priority to, and the benefit of, Korean Patent Application No. 10-2024-0076742, filed on Jun. 13, 2024, in the Korean Intellectual Property Office, the entire disclosure of which is incorporated herein by reference.

### BACKGROUND

### 1. Field

Embodiments of the present disclosure relate to a display apparatus and an electronic apparatus with reduced power consumption.

### 2. Description of the Related Art

Generally, a display apparatus includes a display panel and a display panel driver. The display panel includes a plurality of gate lines, a plurality of data lines, a plurality of emission lines, and a plurality of pixels. The display panel driver includes a gate driver providing a gate signal to the gate lines, a data driver providing a data voltage to the data lines, an emission driver providing an emission signal to the emission lines and a driving controller controlling the gate driver, the data driver and the emission driver.

Generally, when a frequency applied to a display panel driver is high, a power consumption may be increased.

### SUMMARY

Embodiments of the present disclosure provide a display apparatus with reduced power consumption.

Embodiments of the present disclosure also provide an electronic apparatus with reduced power consumption.

1 According to embodiments, a display apparatus may include a display panel including a pixel, a gate driver configured to output gate signals to the display panel, and including a first gate stage group for generating a first gate signals, and including a first gate odd stage group on a first side of the display panel, and a first gate even stage group on a second side of the display panel, and a second gate stage group for generating a second gate signals, and including a second gate odd stage group on the second side, and a second gate even stage group on the first side, and a data driver configured to apply a data voltage to the display panel.

The display panel may further include an odd pixel-row connected to the first gate odd stage group and the second gate odd stage group, and an even pixel-row connected to the first gate even stage group and the second gate even stage group.

The first gate stage group may include a first-first gate stage, a first-second gate stage, a first-third gate stage, and a first-fourth gate stage, wherein the first-third gate stage is configured to receive a first-first gate carry signal of the first-first gate stage, and the first-fourth gate stage is configured to receive a first-second gate carry signal of the first-second gate stage.

The second gate stage group may include a second-first gate stage, a second-second gate stage, a second-third gate stage and a second-fourth gate stage, wherein the second-third gate stage is configured to receive a second-first gate carry signal of the second-first gate stage, and the second-fourth gate stage is configured to receive a second-second gate carry signal of the second-second gate stage.

The display apparatus may further include an emission driver configured to output an emission signal to the display panel, and including an emission stage group for generating the emission signal, the emission stage group including an emission odd stage group on the first side, and an emission even stage group on the second side.

The emission stage group may include a first emission stage, a second emission stage, a third emission stage configured to receive a first emission carry 1 signal of the first emission stage, and a fourth emission stage configured to receive a second emission carry signal of the second emission stage.

The display apparatus may further include a left side clock signal line group on the first side, and a right side clock signal line group on the second side.

The gate driver may further include a third gate stage group for generating third gate signals on the first side, and a fourth gate stage group for generating fourth gate signals on the second side.

The gate driver may further include a third gate stage group for generating third gate signals, and including a third gate odd stage group on the first side, and a third gate even stage group on the second side, and a fourth gate stage group for generating fourth gate signals, and including fourth gate odd stage group on the second side, and a fourth gate even stage group on the first side.

The gate driver may further include an integration gate stage group, wherein at least one integration gate stage of the integration gate stage group includes an integration-carry-signal-generating block configured to generate an integration gate stage carry signal in response to a previous integration gate stage carry signal, a third-gate-signal-generating block configured to generate a third gate signal in response to the integration gate stage carry signal, and a fourth-gate-signal-generating block configured to generate a fourth gate signal in response to the integration gate stage carry signal.

The integration gate stage group may be on the first side.

The integration gate stage group may include an integration gate odd stage group on the first side, and an integration gate even stage group on the second side.

The integration gate odd stage group may include a third integration gate stage and a first integration gate stage configured to receive the previous integration gate stage carry signal of the third integration gate stage as the integration gate stage carry signal, wherein the integration gate even stage group includes a fourth integration gate stage, and a second integration gate stage configured to receive the previous integration gate stage carry signal of the fourth integration gate stage as the integration gate stage carry signal.

According to embodiments, a display apparatus may include a display panel including a pixel, a gate driver configured to output a write gate signal and a bias gate signal to the display panel, and including a bias gate stage group for generating the bias gate signal, the bias gate stage group including a bias gate odd stage group on a first side of the display panel, and a bias gate even stage group on a second side of the display panel, an emission driver configured to output an emission signal to the display panel, and including an emission stage group for generating the emission signal, the emission stage group including an emission odd stage group on the second side, and an emission even stage group on the first side, and a data driver configured to apply a data voltage to the display panel.

The display panel may include an odd pixel-row connected to the bias gate odd stage group and the emission odd stage group, and an even pixel-row connected to the bias gate even stage group and the emission even stage group.

The bias gate stage group may include a first bias gate stage, a second bias gate stage, a third bias gate stage configured to receive a first bias gate carry signal of the first bias gate stage, and a fourth bias gate stage configured to receive a second bias gate carry signal of the second bias gate stage.

The emission stage group may include, a third first emission stage, a fourth first emission stage, a first emission stage configured to apply a first emission carry signal to the third first emission stage, a second emission stage configured to apply a second emission carry signal to the fourth first emission stage.

The pixel may include a driving transistor including a control electrode connected to a first node, a first electrode connected to a second node, and a second electrode connected to a third node, a writing transistor configured to apply the data voltage to the second node in response to the write gate signal, a first emission transistor configured to connect the third node and a fourth node in response to the 1 emission signal, a light-emitting element initialization transistor configured to apply a light-emitting element initialization voltage to the fourth node in response to the bias gate signal, and a light-emitting element including a first electrode connected to the fourth node, and a second electrode for receiving a low power voltage.

The gate driver may be configured to output a compensation gate signal and an initialization gate signal, wherein the pixel further includes a compensation transistor configured to connect the first node and the third node in response to the compensation gate signal, and an initialization transistor configured to apply an initialization voltage to the first node in response to the initialization gate signal.

The gate driver may further include a compensation gate stage group for generating the compensation gate signal, and including a compensation gate odd stage group on the first side and a compensation gate even stage group on the second side, and an initialization gate stage group for generating the initialization gate signal, and including an initialization gate odd stage group on the second side and an initialization gate even stage group on the first side.

According to embodiments, an electronic apparatus may include a display panel including a pixel, a gate driver configured to output gate signals to the display panel, and including a first gate stage group for generating a first gate signals, and including a first gate odd stage group on a first side of the display panel, and a first gate even stage group on a second side of the display panel, and a second gate stage group for generating a second gate signals, and including a second gate odd stage group on the second side, and a second gate even stage group on the first side, and a data driver configured to apply a data voltage to the display panel.

As described above, stages included in a display panel driver may be alternately located on a first side and a second side of the display panel. Accordingly, a frequency of the clock signal applied to the stages may be reduced. The frequency of the clock signal may be reduced, so that a power consumption of the display apparatus may be reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display apparatus according to embodiments of the present disclosure.

FIG. 2 is a diagram illustrating a display region of a display panel included in a display apparatus of FIG. 1.

FIG. 3 is a block diagram illustrating a location of a display panel and a gate driver included on a display apparatus of FIG. 1.

FIG. 4 is a block diagram illustrating location of stages of a gate driver of FIG. 3.

FIG. 5 is a timing diagram illustrating clock signals applied to a gate driver of a conventional display apparatus and output signals outputted from the gate driver of the conventional display apparatus.

FIG. 6 is a timing diagram illustrating clock signals applied to a gate driver included in a display apparatus and output signals.

FIG. 7 is a block diagram illustrating location of a gate driver and an emission driver included in a display apparatus of FIG. 3.

FIG. 8 is a block diagram illustrating location of stages of a gate driver and an emission driver included in a display apparatus of FIG. 3.

FIG. 9 is a circuit diagram illustrating a pixel included in a display apparatus of FIG. 1.

FIG. 10 is a diagram illustrating a location of display panel, a gate driver and an emission driver included in a display apparatus of FIG. 1.

FIG. 11 is a diagram illustrating a location of display panel, a gate driver and an emission driver included in a display apparatus of FIG. 1.

FIG. 12 is a diagram illustrating a location of display panel, a gate driver and an emission driver included in a display apparatus of FIG. 1.

FIG. 13 is a block diagram illustrating an integration gate stage included in a gate driver of FIG. 12.

FIG. 14 is a diagram illustrating a location of display panel, a gate driver and an emission driver included in a display apparatus of FIG. 1.

FIG. 15 is a block diagram illustrating a location of stages of a gate driver of FIG. 3.

FIG. 16 is a circuit diagram illustrating a pixel included in a display apparatus of FIG. 1.

FIG. 17 is a block diagram illustrating an electronic apparatus according to one or more embodiments of the present disclosure.

FIG. 18 is a diagram illustrating an example in which the electronic apparatus of FIG. 17 is implemented as a smart phone.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

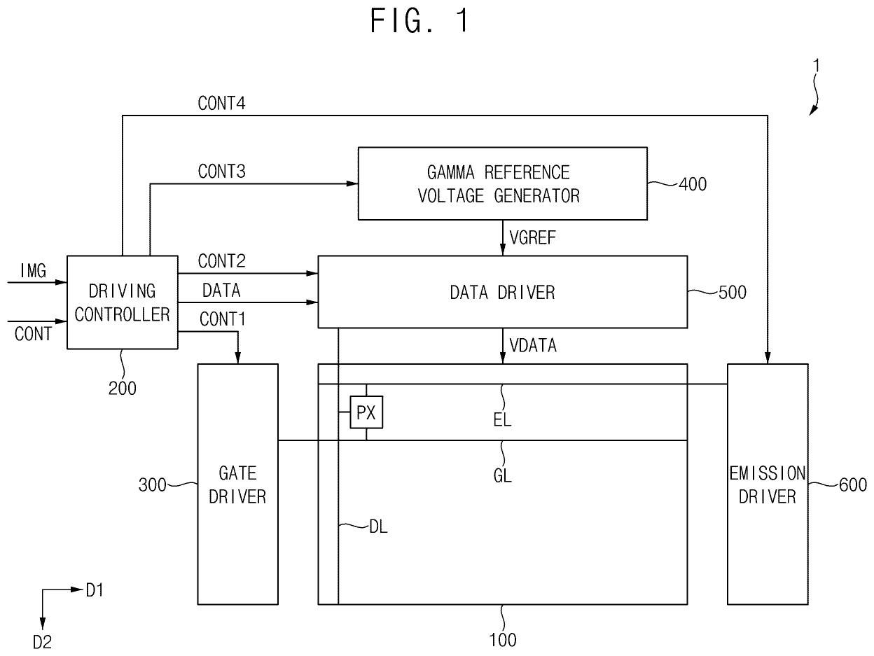

FIG. 1 is a block diagram illustrating a display apparatus 1 according to embodiments of the present disclosure.

Referring to FIG. 1, the display apparatus 1 may include a display panel 100 and a display panel driver 110. The display panel driver 110 may include a driving controller 200, a gate driver 300, a gamma reference voltage generator 400, a data driver 500, and an emission driver 600.

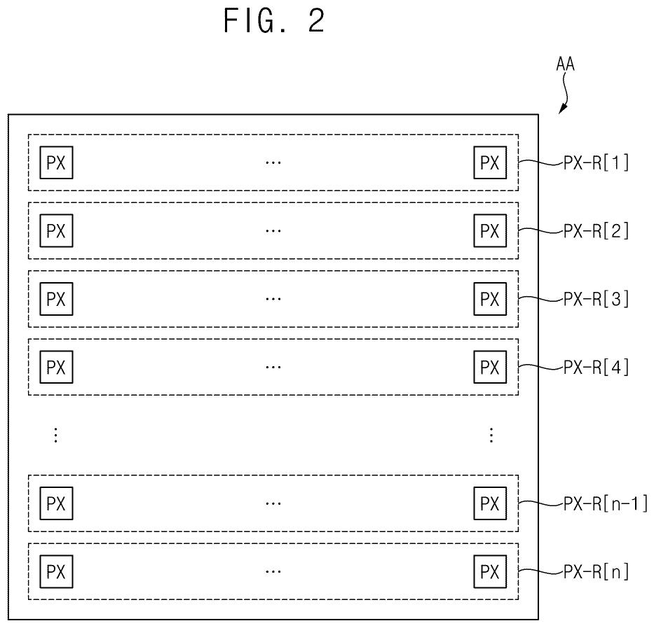

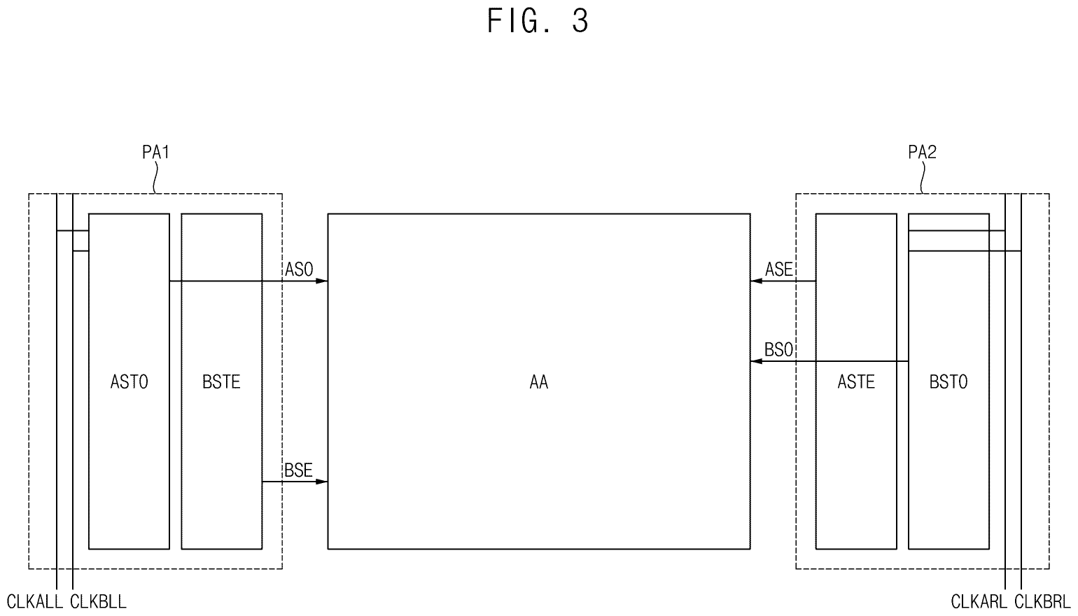

The display panel 100 may have a display region AA of FIG. 2 on which an image is displayed and a peripheral region adjacent to the display region. For example, the peripheral region may include a first peripheral region PA1 of FIG. 3 and a second peripheral region PA2 of FIG. 3.

The display panel 100 may include a plurality of gate lines GL, a plurality of emission lines EL, a plurality of data lines DL, and a plurality of pixels PX electrically connected to the gate lines GL, the emission lines EL and the data lines DL. The gate lines GL may extend in a first direction D1, the emission lines EL may extend in the first direction D1, and the data lines DL may extend in a second direction D2 crossing the first direction D1.

The driving controller 200 may receive input image data IMG and an input control signal CONT from an external apparatus. For example, the input image data IMG may include red image data, green image data, and blue image data. The input image data IMG may include white image data. The input image data IMG may include magenta image data, cyan image data, and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and may output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and may output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and may output the third control signal CONT3 to the gamma reference voltage generator 400.

The driving controller 200 may generate the fourth control signal CONT4 for controlling an operation of the emission driver 600 based on the input control signal CONT, and may output the fourth control signal CONT4 to the emission driver 600.

The gate driver 300 may generate gate signals driving the gate lines GL in response to the first control signal CONT1 received from the driving controller 200. The gate driver 300 may output the gate signals to the gate lines GL. For example, the gate signals may include first gate signals, second gate signals, third gate signals and fourth gate signals. For example, the gate signals may include a plurality of write gate signals, a plurality of compensation gate signals, a plurality of initialization gate signals and a plurality of bias gate signals.

In one or more embodiments, the gate driver 300 may be located in the peripheral region. In one or more embodiments, the gate driver 300 may be integrated in the peripheral region. For example, the gate driver 300 may be located on a first side and/or a second side different from the first side of the display panel 100.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In one or more embodiments, the gamma reference voltage generator 400 may be located in the driving controller 200 or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL.

In one or more embodiments, the data driver 500 may be located in the peripheral region. In one or more embodiments, the data driver 500 may be integrated in the peripheral region.

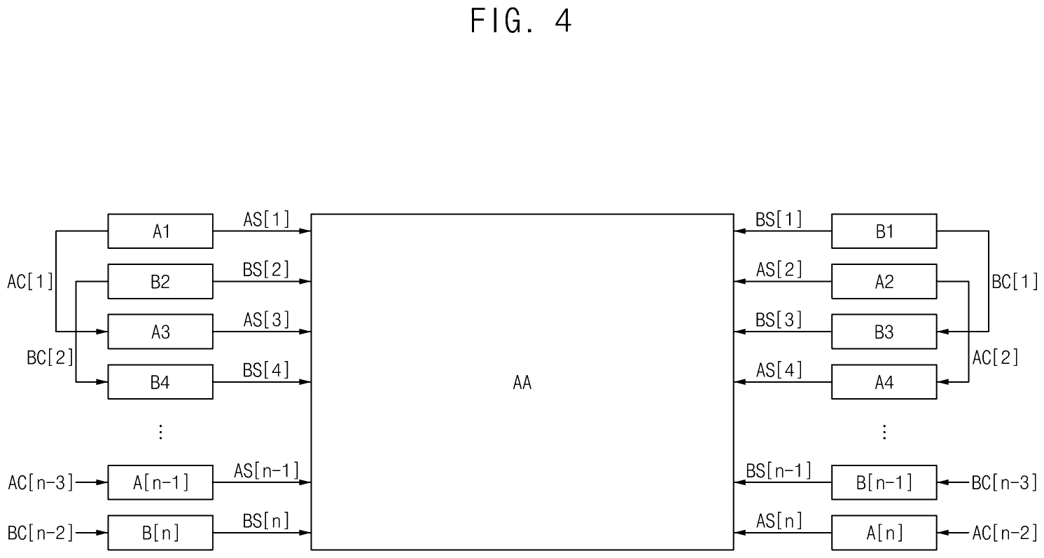

The emission driver 600 may generate emission signal EM of FIG. 4 in response to the fourth control signal CONT4 received from the driving controller 200. The emission driver 600 may output the emission signal to the display panel 100. The fourth control signal CONT4 may include an emission start signal and an emission clock signal.

In one or more embodiments, the emission driver 600 may be located in the peripheral region. In one or more embodiments, the emission driver 600 may be integrated in the peripheral region. For example, the emission driver 600 may be located on the first side and/or the second side of the display panel 100.

Although the gate driver 300 is located on a first side of the display panel 100, and the emission driver 600 is located on a second side of the display panel 100 in FIG. 1 for convenience of explanation, the present disclosure is not limited thereto. The gate driver 300 and the emission driver 600 may be located on the first side of the display panel 100. For example, the gate driver 300 and the emission driver 600 may be located on the peripheral region of the display panel 100 on the same side of the display region of the display panel 100. For example, the gate driver 300 and the emission driver 600 may be formed integrally with each other.

A display apparatus 1 according to one or more embodiments is a device for displaying a video or still image, and may be used as a display screen for various products, such as television, laptops, monitors, billboards, Internet of Things (IoTs), as well as portable electronic devices, such as mobile phone, smart phone, tablet personal computer (PC), mobile communication terminal, electronic notebook, electronic book, portable multimedia player PMP, navigation system, and ultra mobile PC UMPC. In addition, the display apparatus 1 according to one or more embodiments may be used in wearable devices, such as smart watches, watch phones, glasses-type displays, head-mounted displays HMDs, virtual reality (VR) devices, or augmented reality (AR) devices. In addition, the display apparatus 1 according to one or more embodiments may be used as a dashboard of a vehicle, a center information display (CID) located in a center fascia or a dashboard of the vehicle, a room mirror display replacing a side mirror of the vehicle, an entertainment element for a rear seat of the vehicle, and a display located on a rear surface of the front seat.

FIG. 2 is a diagram illustrating a display region AA of a display panel 100 included in a display apparatus 1 of FIG. 1.

Referring to FIG. 1 and FIG. 2, the display panel 100 may include pixels PX. The pixel PX may be located on the display region AA of the display panel 100. The display panel 100 may include a plurality of pixel-rows PX-R[1], PX-R[2], PX-R[3], PX-R[4] to PX-R[n−1], and PX-R[n] For example, a first pixel-row PX-R[1] may be connected to a first-first gate signal A1 of FIG. 1. For example, a second pixel-row PX-R[2] may be connected to a first-second gate stage A2 of FIG. 4. For example, a N-th pixel-row PX-R[n] may be connected to a first-N-th gate signal A[n] of FIG. 4.

FIG. 3 is a block diagram illustrating a location of a display panel 100 and a gate driver 300 included on a display apparatus of FIG. 1.

Referring to FIG. 1 to FIG. 3, the gate driver 300 may include a first gate stage group generating first gate signals ASO and ASE, and a second gate stage group generating second gate signals BSO and BSE.

The first gate stage group may include a first gate odd stage group ASTO and a first gate even stage group ASTE. The first gate odd stage group ASTO may be located on the first side. The first gate odd stage group ASTO may be located on the first peripheral region PA1. The first gate even stage group ASTE may be located on the second side of the display panel 100. The first gate even stage group ASTE may be located on the second peripheral region PA2.

The first gate odd stage group ASTO may output first odd gate signals ASO to the display panel 100. The first odd gate signals ASO may be applied to odd pixel-rows PX-R[1], PX-R[3], . . . . PX-R[n−1].

The first gate even stage group ASTE may output first even gate signals ASE to the display panel 100. The first even gate signals ASE may be applied to even pixel-rows PX-R[2], PX-R[4], . . . . PX-R[n].

The second gate stage group may include a second gate odd stage group BSTO and a second gate even stage group BSTE. The second gate odd stage group BSTO may be located on the second side. The second gate odd stage group BSTO may be located on the second peripheral region PA2. The second gate even stage group BSTE may be located on the first side of the display panel 100. The second gate even stage group BSTE may be located on the first peripheral region PA1.

The second gate odd stage group BSTO may output second odd gate signals BSO to the display panel 100. The second odd gate signals BSO may be applied to the odd pixel-rows PX-R[1], PX-R[3], . . . . PX-R[n−1].

The second gate even stage group BSTE may output second even gate signals BSE to the display panel 100. The second even gate signals BSE may be applied to the even pixel-rows PX-R[2], PX-R[4], . . . . PX-R[n].

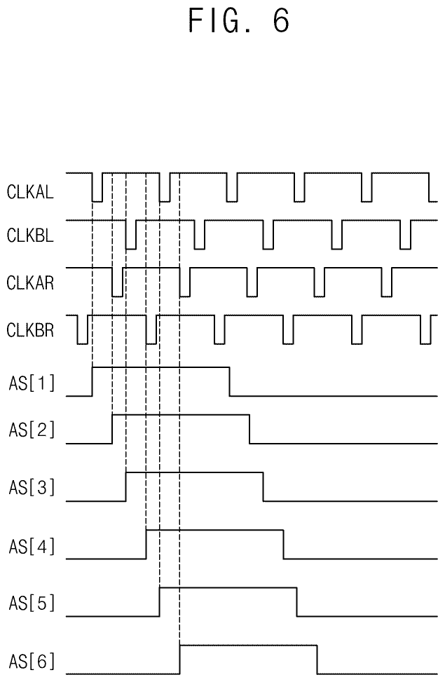

The first gate stage group may receive clock signals CLKAL, CLKBL, CLKAR, and CLKBR of FIG. 6. The clock signals CLKAL, CLKBL, CLKAR, and CLKBR of FIG. 6 may include a left clock signal group CLKAL and CLKBL of FIG. 6 and a right clock signal group CLKAR and CLKBR of FIG. 6.

The left clock signal group CLKAL and CLKBL of FIG. 6 may include a first left clock signal CLKAL of FIG. 6 and a second left clock signal CLKBL of FIG. 6. The first left clock signal CLKAL of FIG. 6 may be applied to a first left clock signal line CLKALL. The second left clock signal CLKBL of FIG. 6 may be applied to a second left clock signal line CLKBLL. A left clock signal line group may include the first left clock signal line CLKALL and the second left clock signal line CLKBLL. The left clock signal line group may be located on the first peripheral region PA1.

The right clock signal group CLKAR and CLKBR of FIG. 6 may include a first right clock signal CLKAR of FIG. 6 and a second right clock signal CLKBR of FIG. 6. The first right clock signal CLKAR of FIG. 6 may be applied to a first right clock signal line CLKARL. The second right clock signal CLKBR of FIG. 6 may be applied to a second right clock signal line CLKBRL. A right clock signal line group may include the first right clock signal line CLKARL and the second right clock signal line CLKBRL. The right clock signal line group may be located on the second peripheral region PA2.

The first gate odd stage group ASTO may be connected to the left clock signal line group CLKALL and CLKBLL. The first gate odd stage group ASTO may generate the first odd gate signals ASO based on the left clock signal group CLKAL and CLKBL of FIG. 6.

The first gate even stage group ASTE may be connected to the right clock signal line group CLKARL and CLKBRL. The first gate even stage group ASTE may generate the first even gate signals ASE based on the right clock signal group CLKAR and CLKBR of FIG. 6.

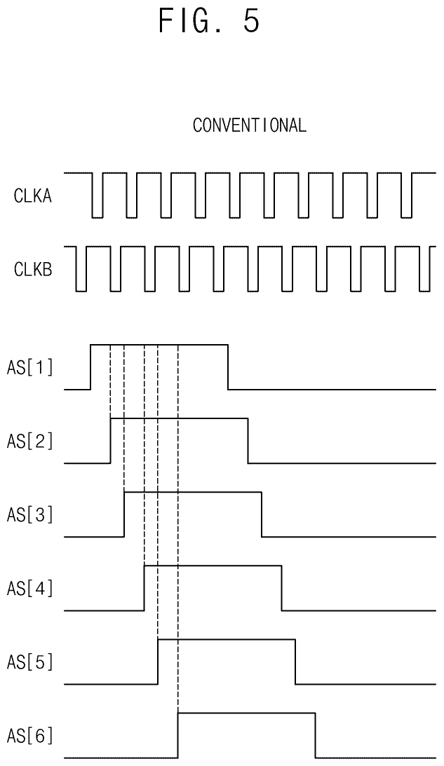

FIG. 4 is a block diagram illustrating location of stages of a gate driver 300 of FIG. 3. FIG. 5 is a timing diagram illustrating clock signals applied to a gate driver of a conventional display apparatus and output signals outputted from the gate driver of the conventional display apparatus. FIG. 6 is a timing diagram illustrating clock signals applied to a gate driver 300 included in a display apparatus 1 and output signals.

Referring to FIG. 1 to FIG. 6, the first gate odd stage group ASTO may include a first-first gate stage A1, a first-third gate stage A3 to a first-N−1-th gate stage A[n−1]. The first-first gate stage A1 may generate a first-first gate signal AS[1]. The first-third gate stage A3 may generate a first-third gate signal AS[3]. The first-N−1-th gate stage A[n−1] may generate a first-N−1-th gate signal AS[n−1]. For example, the first-first gate signal AS[1] may be applied to the first pixel-row PX-R[1]. For example, the first-third gate signal AS[3] may be applied to the third pixel-row PX-R[3]. For example, the first-N−1-th gate signal AS[n−1] may be applied to the N−1-th pixel-row PX-R[n−1].

The first-third gate stage A3 may generate the first-third gate signal AS[3] in response to a first-first gate carry signal AC[1] of the first-first gate stage A1. The first-N−1-th gate stage A[n−1] may generate the first-N−1-th gate signal AS[n−1] in response to a first-N−3-th gate carry signal AC[n−3] of the first-N−3-th gate stage A[n−3].

The second gate even stage group BSTE may include a second-second gate stage B2, a second-fourth gate stage B4 to a second-N-th gate stage B[n]. The second-second gate stage B2 may generate a second-second gate signal BS[2]. The second-fourth gate stage B4 may generate a second-fourth gate signal BS[4]. The second-N-th gate stage B[n] may generate a second-N-th gate signal BS[n]. For example, the second-second gate signal BS[2] may be applied to the second pixel-row PX-R[2]. For example, the second-fourth gate signal BS[4] may be applied to the fourth pixel-row PX-R[4]. For example, the second-N-th gate signal BS[n] may be applied to the N-th pixel-row PX-R[n].

The second-fourth gate stage B4 may generate the second-fourth gate signal BS[4] in response to a second-second gate carry signal BC[2] of the second-second gate stage B2. The second-N-th gate stage B[n] may generate the second-N-th gate signal BS[n] in response to a second-N−2-th gate carry signal BC[n−2] of the second-N−2-th gate stage B[n−2].

The second gate odd stage group BSTO may include a second-first gate stage B1, a second-third gate stage B3 to a second-N−1-th gate stage B[n−1]. The second-first gate stage B1 may generate a second-first gate signal BS[1]. The second-third gate stage B3 may generate a second-third gate signal BS[3]. The second-N−1-th gate stage B[n−1] may generate a second-N−1-th gate signal BS[n−1]. For example, the second-first gate signal BS[1] may be applied to the first pixel-row PX-R[1]. For example, the second-third gate signal BS[3] may be applied to the third pixel-row PX-R[3]. For example, the second-N−1-th gate signal BS[n−1] may be applied to the N−1-th pixel-row PX-R[n−1].

The second-third gate stage B3 may generate the second-third gate signal BS[3] in response to a second-first gate carry signal BC[1] of the second-first gate stage B1. The second-N−1-th gate stage B[n−1] may generate the second-N−1-th gate signal BS[n−1] in response to a second-N−3-th gate carry signal BC[n−3] of the second-N−3-th gate stage B[n−3].

The first gate even stage group ASTE may include a first-second gate stage A2, a first-fourth gate stage A4 to a first-N-th gate stage A[n]. The first-second gate stage A2 may generate a first-second gate signal AS[2]. The first-fourth gate stage A4 may generate a first-fourth gate signal AS[4]. The first-N-th gate stage A[n] may generate a first-N-th gate signal AS[n]. For example, the first-second gate signal AS[2] may be applied to the second pixel-row PX-R[2]. For example, the first-fourth gate signal AS[4] may be applied to the fourth pixel-row PX-R[4]. For example, the first-N-th gate signal AS[n] may be applied to the N-th pixel-row PX-R[n].

The first-fourth gate stage A4 may generate the first-fourth gate signal AS[4] in response to a first-second gate carry signal AC[2] of the first-second gate stage A2. The first-N-th gate stage A[n] may generate the first-N-th gate signal AS[n] in response to a first-N−2-th gate carry signal AC[n−2] of the first-N−2-th gate stage A[n−2].

For example, the first-first gate stage A1 to the first-N-th gate stage A[n] included in the first gate stage group may be alternately located on the first peripheral region PA1 and the second peripheral region PA2.

For example, the second-first gate stage B1 to the second-N-th gate stage B[n] included in the second gate stage group may be alternately located on the first peripheral region PA1 and the second peripheral region PA2.

For example, the first-first gate stage A1 and the second-second gate stage B2 may be located spaced apart from each other in the first direction D1. For example, the second-second gate stage B2 and the first-third gate stage A3 may be located spaced apart from each other in the first direction D1. For example, the first-third gate stage A3 and the second-fourth gate stage B4 may be located spaced apart from each other in the first direction D1.

For example, the second-first gate stage B1 and the first-second gate stage A2 may be located spaced apart from each other in the first direction D1. For example, the first-second gate stage A2 and the second-third gate stage B3 may be located spaced apart from each other in the first direction D1. For example, the second-third gate stage B3 and the first-fourth gate stage A4 may be located spaced apart from each other in the first direction D1.

In a conventional display apparatus, gate stages for generating gate signals may be sequentially located on a first side and/or a second side of a display panel. Accordingly, the stages may generate first gate signals AS[1], AS[2], AS[3], AS[4], AS[5], and AS[6] based on clock signals CLKA, CLKB.

In contrast, the first-first gate stage A1 to the first-N-th gate stage A[n] included in the first gate stage group may be alternately located on the first side and the second side of the display panel 100. The first-first gate stage A1 to the first-Nth gate stage A[n] included in the first gate stage group may be alternately located on the first peripheral region PA1 and the second peripheral region PA2.

Additionally, the first gate odd stage group ASTO may generate first odd gate signals ASO based on the left clock signal group CLKAL and CLKBL. The first gate even stage group ASTE may generate the first even gate signals ASE based on the right clock signal group CLKAR and CLKBR. The first-third gate stage A3 may output the first-third gate signal AS[3] in response to the first-first gate carry signal AC[1] of the first-first gate stage A1.

Accordingly, the first-third gate stage A3 may generate the first-third gate signal AS[3] in response to the first-first gate carry signal AC[1] of the first-first gate stage A1 rather than the first-second gate carry signal AC[2] of the first-second gate stage A2, so that the clock signals CLKAL, CLKBL, CLKAR, and CLKBR may be set to have a longer period than the clock signals CLKA and CLKB. The period of the clock signals CLKAL, CLKBL, CLKAR, and CLKBR may be set longer than the period of the clock signals CLKA and CLKB, so that frequencies of the clock signals CLKAL, CLKBL, CLKAR, and CLKBR may be reduced. The frequencies of the clock signals CLKAL, CLKBL, CLKAR, and CLKBR may be reduced, so that a power consumption of the display apparatus 1 may be reduced.

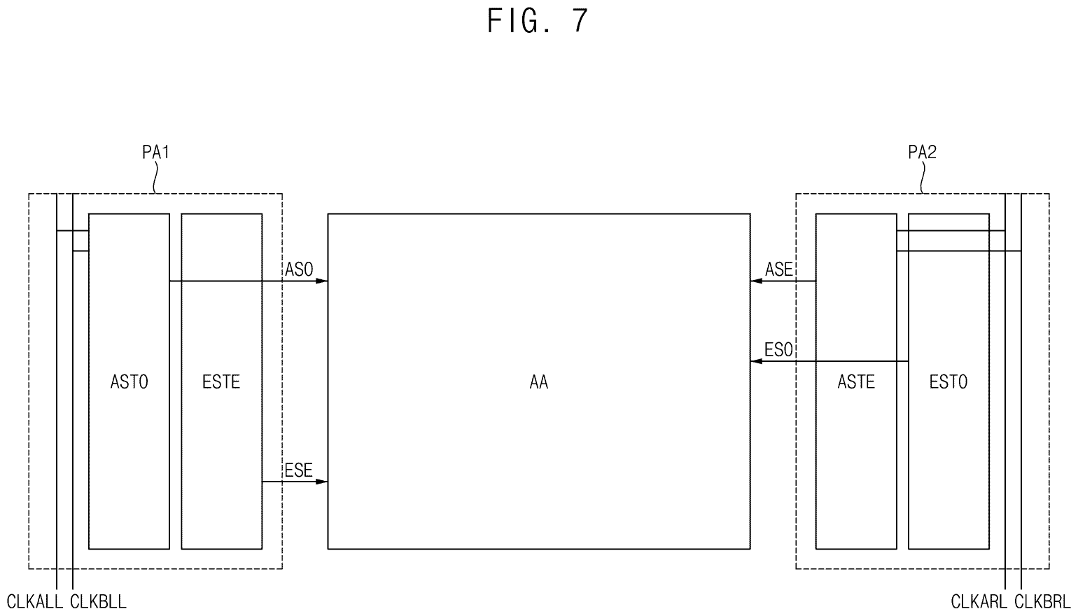

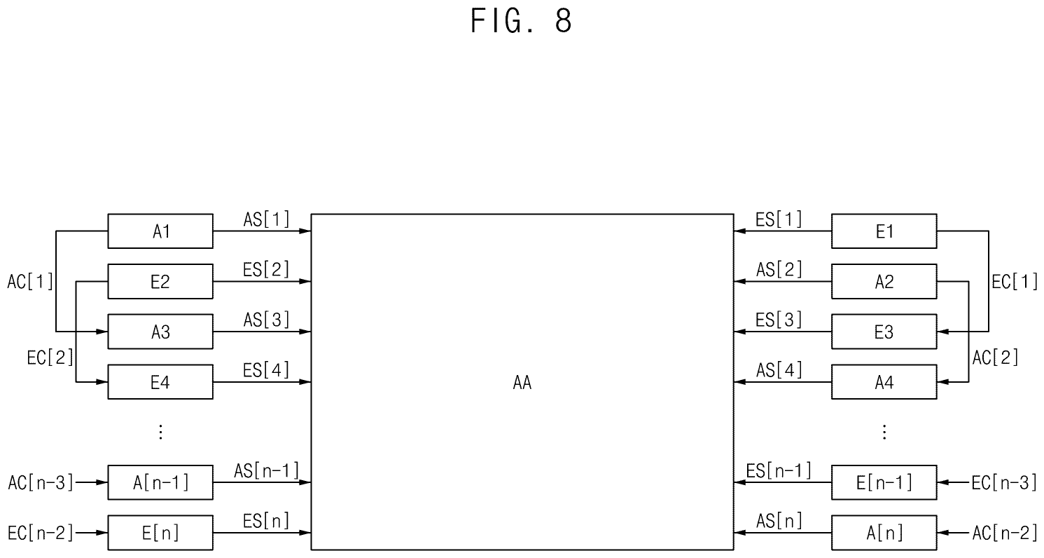

FIG. 7 is a block diagram illustrating location of a gate driver 300 and an emission driver 600 included in a display apparatus 1 of FIG. 3. FIG. 8 is a block diagram illustrating location of stages of a gate driver 300 and an emission driver 600 included in a display apparatus 1 of FIG. 3.

Referring to FIG. 1, FIG. 3 and FIG. 5 to FIG. 6, the gate driver 300 may include a first gate stage group generating first the gate signals AS[1], AS[2], AS[3], AS[4], AS[n−1], and AS[n]. The emission driver 600 may include an emission stage group generating a plurality of emission signals ES[1], ES[2], ES[3], ES[4], ES[n], and ES[n−1].

The first gate stage group may include a first gate odd stage group ASTO and a first gate even stage group ASTE. The first gate odd stage group ASTO may be located on the first side. The first gate odd stage group ASTO may be located on the first peripheral region PA1. The first gate even stage group ASTE may be located on the second side of the display panel 100. The first gate even stage group ASTE may be located on the second peripheral region PA2.

The first gate odd stage group ASTO may output first odd gate signals ASO to the display panel 100. The first odd gate signals ASO may be applied to odd pixel-rows PX-R[1], PX-R[3], . . . . PX-R[n−1].

The first gate even stage group ASTE may output first even gate signals ASE to the display panel 100. The first even gate signals ASE may be applied to even pixel-rows PX-R[2], PX-R[4], . . . . PX-R[n].

The emission stage group may include an emission odd stage group ESTO and an emission even stage group ESTE. The emission odd stage group ESTO may be located on the second side. The emission odd stage group ESTO may be located on the second peripheral region PA2. The emission even stage group ESTE may be located on the first side of the display panel 100. The emission even stage group ESTE may be located on the first peripheral region PA1.

The emission odd stage group ESTO may output odd emission signals ESO to the display panel 100. The emission odd gate signals ESO may be applied to the odd pixel-rows PX-R[1], PX-R[3], . . . . PX-R[n−1].

The emission even stage group ESTE may output even emission signals ESE to the display panel 100. The even emission signals ESE may be applied to the even pixel-rows PX-R[2], PX-R[4], . . . . PX-R[n].

The first gate stage group may receive clock signals CLKAL, CLKBL, CLKAR, and CLKBR. The clock signals CLKAL, CLKBL, CLKAR, and CLKBR may include a left clock signal group CLKAL and CLKBL and a right clock signal group CLKAR and CLKBR.

The left clock signal group CLKAL and CLKBL of FIG. 6 may include a first left clock signal CLKAL of FIG. 6 and a second left clock signal CLKBL of FIG. 6. The first left clock signal CLKAL of FIG. 6 may be applied to a first left clock signal line CLKALL. The second left clock signal CLKBL of FIG. 6 may be applied to a second left clock signal line CLKBLL. A left clock signal line group may include the first left clock signal line CLKALL and the second left clock signal line CLKBLL. The left clock signal line group may be located on the first peripheral region PA1.

The right clock signal group CLKAR and CLKBR of FIG. 6 may include a first right clock signal CLKAR of FIG. 6 and a second right clock signal CLKBR of FIG. 6. The first right clock signal CLKAR of FIG. 6 may be applied to a first right clock signal line CLKARL. The second right clock signal CLKBR of FIG. 6 may be applied to a second right clock signal line CLKBRL. A right clock signal line group may include the first right clock signal line CLKARL and the second right clock signal line CLKBRL. The right clock signal line group may be located on the second peripheral region PA2.

The first gate odd stage group ASTO may be connected to the left clock signal line group CLKALL and CLKBLL. The first gate odd stage group ASTO may generate the first odd gate signals ASO based on the left clock signal group CLKAL and CLKBL.

The first gate even stage group ASTE may be connected to the right clock signal line group CLKARL and CLKBRL. The first gate even stage group ASTE may generate the first even gate signals ASE based on the right clock signal group CLKAR and CLKBR.

The first gate odd stage group ASTO may include a first-first gate stage A1, a first-third gate stage A3 to a first-N−1-th gate stage A[n−1]. The first-first gate stage A1 may generate a first-first gate signal AS[1]. The first-third gate stage A3 may generate a first-third gate signal AS[3]. The first-N−1-th gate stage A[n−1] may generate a first-N−1-th gate signal AS[n−1]. For example, the first-first gate signal AS[1] may be applied to the first pixel-row PX-R[1]. For example, the first-third gate signal AS[3] may be applied to the third pixel-row PX-R[3]. For example, the first-N−1-th gate signal AS[n−1] may be applied to the N−1-th pixel-row PX-R[n−1].

The first-third gate stage A3 may generate the first-third gate signal AS[3] in response to a first-first gate carry signal AC[1] of the first-first gate stage A1. The first-N−1-th gate stage A[n−1] may generate the first-N−1-th gate signal AS[n−1] in response to a first-N−3-th gate carry signal AC[n−3] of the first-N−3-th gate stage A[n−3].

The emission even stage group ESTE may include a second emission stage E2, a fourth emission stage E4 to an N-th emission stage E[n]. The second emission stage E2 may generate a second emission signal ES[2]. The fourth emission stage E4 may generate a fourth gate signal ES[4]. The N-th emission stage E[n] may generate an N-th emission signal ES[n]. For example, the second emission signal ES[2] may be applied to the second pixel-row PX-R[2]. For example, the fourth emission signal ES[4] may be applied to the fourth pixel-row PX-R[4]. For example, the N-th gate signal ES[n] may be applied to the N-th pixel-row PX-R[n].

The fourth emission stage E4 may generate the fourth emission signal ES[4] in response to a second emission carry signal EC[2] of the second gate stage E2. The N-th emission stage E[n] may generate the N-th emission signal ES[n] in response to an N−2-th emission carry signal EC[n−2] of the N−2-th emission stage E[n−2].

The emission odd stage group ESTO may include a first emission stage E1, a third emission stage E3 to an N−1-th emission stage E[n−1]. The first gate stage E1 may generate a first emission signal ES[1]. The third emission stage E3 may generate a third emission signal ES[3]. The N−1-th emission stage E[n−1] may generate an N−1-th emission signal ES[n−1]. For example, the first emission signal ES[1] may be applied to the first pixel-row PX-R[1]. For example, the third emission signal ES[3] may be applied to the third pixel-row PX-R[3]. For example, the N−1-th emission signal ES[n−1] may be applied to the N−1-th pixel-row PX-R[n−1].

The third emission stage E3 may generate the third emission signal ES[3] in response to a first emission carry signal EC[1] of the first emission stage E1. The N−1-th emission stage E[n−1] may generate the N−1-th emission signal ES[n−1] in response to an N−3-th emission carry signal EC[n−3] of the N−3-th emission stage E[n−3].

The first gate even stage group ASTE may include a first-second gate stage A2, a first-fourth gate stage A4 to a first-N-th gate stage A[n]. The first-second gate stage A2 may generate a first-second gate signal AS[2]. The first-fourth gate stage A4 may generate a first-fourth gate signal AS[4]. The first-N-th gate stage A[n] may generate a first-N-th gate signal AS[n]. For example, the first-second gate signal AS[2] may be applied to the second pixel-row PX-R[2]. For example, the first-fourth gate signal AS[4] may be applied to the fourth pixel-row PX-R[4]. For example, the first-N-th gate signal AS[n] may be applied to the N-th pixel-row PX-R[n].

The first-fourth gate stage A4 may generate the first-fourth gate signal AS[4] in response to a first-second gate carry signal AC[2] of the first-second gate stage A2. The first-N-th gate stage A[n] may generate the first-N-th gate signal AS[n] in response to a first-N−2-th gate carry signal AC[n−2] of the first-N−2-th gate stage A[n−2].

For example, the first-first gate stage A1 to the first-N-th gate stage A[n] included in the first gate stage group may be alternately located on the first peripheral region PA1 and the second peripheral region PA2.

For example, the first emission stage E1 to the N-th emission stage E[n] included in the emission stage group may be alternately located on the first peripheral region PA1 and the second peripheral region PA2.

For example, the first-first gate stage A1 and the second emission stage E2 may be located spaced apart from each other (e.g., adjacent to each other) in the first direction D1. For example, the second emission stage E2 and the first-third gate stage A3 may be located spaced apart from each other in the first direction D1. For example, the first-third gate stage A3 and the fourth emission stage E4 may be located spaced apart from each other in the first direction D1.

For example, the first emission stage E1 and the first-second gate stage A2 may be located spaced apart from each other (e.g., adjacent to each other) in the first direction D1. For example, the first-second gate stage A2 and the third emission stage E3 may be located spaced apart from each other in the first direction D1. For example, the third emission stage E3 and the first-fourth gate stage A4 may be located spaced apart from each other in the first direction D1.

In a conventional display apparatus, gate stages for generating gate signals may be sequentially located on a first side and/or a second side of a display panel. Accordingly, the stages may generate first gate signals AS[1], AS[2], AS[3], AS[4], AS[5], and AS[6] based on clock signals CLKA, CLKB.

In contrast, the first-first gate stage A1 to the first-N-th gate stage A[n] included in the first gate stage group may be alternately located on the first side and the second side of the display panel 100. The first-first gate stage A1 to the first-Nth gate stage A[n] included in the first gate stage group may be alternately located on the first peripheral region PA1 and the second peripheral region PA2.

Additionally, the first gate odd stage group ASTO may generate first odd gate signals ASO based on the left clock signal group CLKAL and CLKBL. The first gate even stage group ASTE may generate the first even gate signals ASE based on the right clock signal group CLKAR and CLKBR. The first-third gate stage A3 may output the first-third gate signal AS[3] in response to the first-first gate carry signal AC[1] of the first-first gate stage A1.

Accordingly, the first-third gate stage A3 may generate the first-third gate signal AS[3] in response to the first-first gate carry signal AC[1] of the first-first gate stage A1 rather than the first-second gate carry signal AC[2] of the first-second gate stage A2, so that the clock signals CLKAL, CLKBL, CLKAR, and CLKBR may be set to have a longer period than the clock signals CLKA and CLKB. The period of the clock signals CLKAL, CLKBL, CLKAR, and CLKBR may be set longer than the period of the clock signals CLKA and CLKB, so that frequencies of the clock signals CLKAL, CLKBL, CLKAR, and CLKBR may be reduced. The frequencies of the clock signals CLKAL, CLKBL, CLKAR, and CLKBR may be reduced, so that a power consumption of the display apparatus 1 may be reduced.

Additionally, the first emission stage E1 to the N-th emission stage E[n] included in the emission stage group may be alternately located on the first side and the second side of the display panel 100. The first emission stage E1 to the Nth emission stage E[n] included in the emission stage group may be alternately located on the first peripheral region PA1 and the second peripheral region PA2.

Additionally, the emission odd stage group ESTO may generate an odd emission signals ESO based on the left clock signal group CLKAL and CLKBL. The even emission stage group ESTE may generate the even emission signals ESE based on the right clock signal group CLKAR and CLKBR. The third emission stage E3 may output the third emission signal ES[3] in response to the first emission carry signal EC[1] of the first emission stage E1.

Accordingly, the third emission stage E3 may generate the third emission signal ES[3] in response to the first emission carry signal EC[1] of the first emission stage E1 rather than the second emission carry signal EC[2] of the second emission stage E2, so that the emission clock signals may be set to have a longer period than the clock signals CLKA and CLKB. The period of the emission clock signals may be set longer than the period of the clock signals CLKA and CLKB, so that frequencies of the emission clock signals may be reduced. The frequencies of the emission clock signals may be reduced, so that a power consumption of the display apparatus 1 may be further reduced.

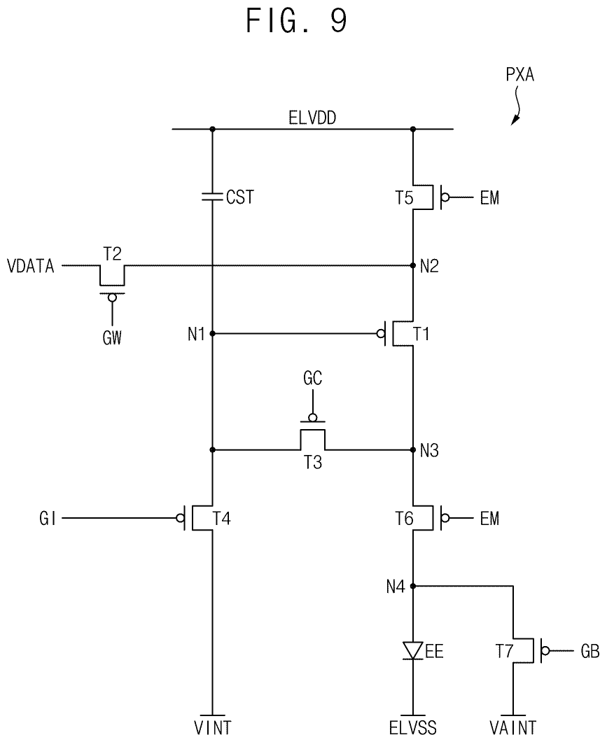

FIG. 9 is a circuit diagram illustrating a pixel PX included in a display apparatus 1 of FIG. 1.

Referring to FIG. 1 and FIG. 9, a pixel PXA may include a first transistor T1, a second transistor T2, a third transistor T3, a fourth transistor T4, a fifth transistor T5, a sixth transistor T6, a seventh transistor T7, a storage capacitor CST, and a light-emitting element EE.

The first transistor T1 may include a control electrode connected to a first node N1, a first electrode connected to a second node N2, and a second electrode connected to a third node N3. The first transistor T1 may generate a driving current based on a voltage of the first node N1. For example, the first transistor T1 may be called a driving transistor.

The second transistor T2 may include a control electrode for receiving the write gate signal GW, a first electrode for receiving the data voltage VDATA, and a second electrode connected to the second node N2. The second transistor T2 may apply the data voltage VDATA to the second node N2 in response to the write gate signal GW.

The third transistor T3 may include a control electrode for receiving the compensation gate signal GC, a first electrode connected to the third node N3, and a second electrode connected to the first node N1. The third transistor T3 may connect the first node N1 and the third node N3 in response to the compensation gate signal GC. For example, the third transistor T3 may diode-connect the first transistor T1 in response to the compensation gate signal GC. For example, the third transistor T3 may be called a compensation transistor (e.g., in the claims).

The fourth transistor T4 may include a control electrode for receiving the initialization gate signal GI, a first electrode for receiving the initialization voltage VINT, and a second electrode connected to the first node N1. The fourth transistor T4 may apply the initialization voltage VINT to the first node N1 in response to the initialization gate signal GI. For example, the fourth transistor T4 may be called an initialization transistor (e.g., in the claims).

The fifth transistor T5 may include a control electrode for receiving the emission signal EM, a first electrode for receiving a high power voltage ELVDD, and a second electrode connected to the second node N2. The fifth transistor T5 may apply the high power voltage ELVDD to the second node N2 in response to the emission signal EM. For example, the fifth transistor T5 may be called a second emission signal.

The sixth transistor T6 may include a control electrode for receiving the emission signal EM, a first electrode connected to the third node N3, and a second electrode connected to a fourth node N4. The sixth transistor T6 may connect the third node N3 and the fourth node N4 in response to the emission signal EM. For example, the sixth transistor T6 may be called a first emission transistor (e.g., in the claims).

The seventh transistor T7 may include a control electrode for receiving the bias gate signal GB, a first electrode for receiving a light-emitting element initialization voltage VAINT, and a second electrode connected to the fourth node N4. The seventh transistor T7 may apply the light-emitting element initialization voltage VAINT to the fourth node N4 in response to the bias gate signal GB. For example, the light-emitting element initialization voltage VAINT may be lower than a low power voltage ELVSS. The fourth node N4 may receive the light-emitting element initialization voltage VAINT, so that a black characteristic of the pixel PXA may be improved.

The storage capacitor CST may include a first electrode for receiving the high power voltage ELVDD, and a second electrode connected to the first node N1. The storage capacitor CST may store the voltage of the first node N1.

The light-emitting element EE may include a first electrode connected to the fourth node N4, and a second electrode for receiving the low power voltage ELVSS. The light-emitting element EE may emit light based on the driving current.

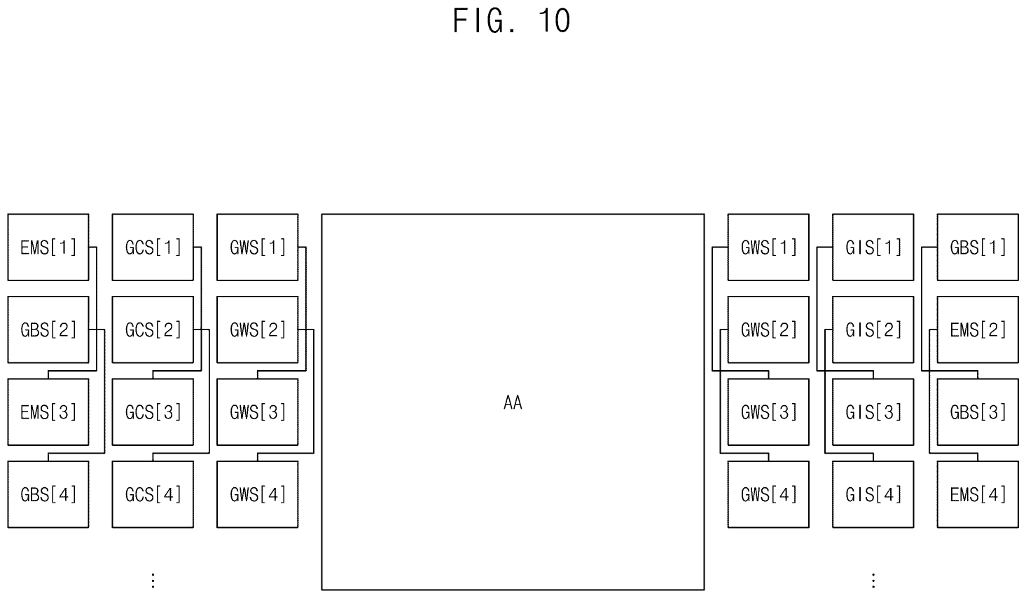

FIG. 10 is a diagram illustrating a location of display panel 100, a gate driver 300 and an emission driver 600 included in a display apparatus 1 of FIG. 1.

Referring to FIG. 1 to FIG. 10, the gate driver 300 may include a write gate stage group GWS[1], GWS[2], GWS[3], GWS[4], . . . , a compensation gate stage group GCS[1], GCS[2], GCS[3], GCS[4], . . . , an initialization gate stage group GIS[1], GIS[2], GIS[3], GIS[4], . . . and a bias gate stage group GBS[1], GBS[2], GBS[3], GBS[4], . . . .

The write gate stage group GWS[1], GWS[2], GWS[3], GWS[4], . . . may generate the write gate signal GW applied to the pixel PX. The compensation gate stage group GCS[1], GCS[2], GCS[3], GCS[4], . . . may generate the compensation gate signal GC applied to the pixel PX. The initialization gate stage group GIS[1], GIS[2], GIS[3], GIS[4], . . . may generate the initialization gate signal GI applied to the pixel PX. The bias gate stage group GBS[1], GBS[2], GBS[3], GBS[4], . . . may generate the bias gate signal GB applied to the pixel PX.

The emission driver 600 may include an emission stage group EMS[1], EMS[2], EMS[3], EMS[4], . . . . The emission stage group EMS[1], EMS[2], EMS[3], EMS[4], . . . may generate the emission signal EM applied to pixel PX.

The emission stage group EMS[1], EMS[2], EMS[3], EMS[4], . . . may be alternately located on the first peripheral region PA1 and the second peripheral region PA2. For example, a first emission stage EMS[1] may be located on the first peripheral region PA1. For example, a second emission stage EMS[2] may be located on the second peripheral region PA2. For example, a third emission stage EMS[3] may be located on the first peripheral region PA1. For example, a fourth emission stage EMS[4] may be located on the second peripheral region PA2. The emission stage group EMS[1], EMS[2], EMS[3], EMS[4], . . . may include an emission odd stage group EMS[1], EMS[3], . . . and an emission even stage group EMS[2], EMS[4], . . . . The emission odd stage group EMS[1], EMS[3], . . . may be located on the first side of the display panel 100. The emission odd stage group EMS[1], EMS[3], . . . may be located on the first peripheral region PA1. The emission even stage group EMS[2], EMS[4], . . . may be located on the second side of the display panel 100. The emission even stage group EMS[2], EMS[4], . . . may be located on the second peripheral region PA2.

The bias gate stage group GBS[1], GBS[2], GBS[3], GBS[4], . . . may be alternately located on the first peripheral region PA1 and the second peripheral region PA2. For example, a first bias gate stage GBS[1] may be located on the second peripheral region PA2. For example, a second bias gate stage GBS[2] may be located on the first peripheral region PA1. For example, a third bias gate stage GBS[3] may be located on the second peripheral region PA2. For example, a fourth bias gate stage GBS[4] may be located on the first peripheral region PA1. The bias gate stage group GBS[1], GBS[2], GBS[3], GBS[4], . . . may include a bias gate odd stage group GBS[1], GBS[3], . . . and a bias gate even stage group GBS[2], GBS[4], . . . . The bias gate odd stage group GBS[1], GBS[3], . . . may be located on the second side of the display panel 100. The bias gate odd stage group GBS[1], GBS[3], . . . may be located on the second peripheral region PA2. The bias gate even stage group GBS[2], GBS[4], . . . may be located on the first side of the display panel 100. The bias gate even stage group GBS[2], GBS[4], . . . may be located on the first peripheral region PA1.

For example, the emission odd stage group EMS[1], EMS[3], . . . and the bias gate even stage group GBS[2], GBS[4], . . . may be alternately located on the first peripheral region PA1. For example, the emission even stage group EMS[2], EMS[4], . . . and the bias gate odd stage group GBS[1], GBS[3], . . . may be alternately located on the second peripheral region PA2.

The compensation gate stage group GCS[1], GCS[2], GCS[3], GCS[4], . . . may be located on the first side or the second side of the display panel 100. For example, the compensation gate stage group GCS[1], GCS[2], GCS[3], GCS[4], . . . may be located on the first peripheral region PA1 or the second peripheral region PA2. The compensation gate stage group GCS[1], GCS[2], GCS[3], GCS[4], . . . may be sequentially located on the first side and the second side of the display panel 100.

The initialization gate stage group GIS[1], GIS[2], GIS[3], GIS[4], . . . may be located on the first side or the second side of the display panel 100. For example, the initialization gate stage group GIS[1], GIS[2], GIS[3], GIS[4], . . . may be located on the first peripheral region PA1 or the second peripheral region PA2. The initialization gate stage group GIS[1], GIS[2], GIS[3], GIS[4], . . . may be sequentially located on the first side and the second side of the display panel 100.

The write gate stage group GWS[1], GWS[2], GWS[3], GWS[4], . . . may be located on the first side or the second side of the display panel 100. For example, the write gate stage group GWS[1], GWS[2], GWS[3], GWS[4], . . . may be located on the first peripheral region PA1 or the second peripheral region PA2. The write gate stage group GWS[1], GWS[2], GWS[3], GWS[4], . . . may be sequentially located on the first side and the second side of the display panel 100.

The bias gate odd stage group GBS[1], GBS[3], . . . may generate bias odd gate signals based on the right clock signal group CLKAR and CLKBR. The bias gate even stage group GBS[2], GBS[4], . . . may generate bias even gate signals based on the left clock signal group CLKAL and CLKBL. The third bias gate stage GBS[3] may output a third bias gate signal GB[3] in response to a first bias gate carry signal of the first bias gate stage GB[1].

Accordingly, the third bias gate stage GBS[3] may generate the third bias gate signal in response to the first bias gate carry signal of the first bias gate stage GBS[1] rather than the second bias gate carry signal of the second bias gate stage GBS[2], so that the bias gate clock signal may be set to have a longer period than the clock signals CLKA and CLKB. The period of the bias gate clock signals may be set longer than the period of the clock signals CLKA and CLKB, so that frequencies of the bias gate clock signals may be reduced. The frequencies of the bias clock signals may be reduced, so that a power consumption of the display apparatus 1 may be reduced.

Additionally, the emission odd stage group EMS[1], EMS[3], . . . may generate an odd emission signals based on the left emission clock signal group. The even emission stage group EMS[2], EMS[4], . . . may generate the even emission signals based on the right emission clock signal group. The third emission stage EMS[3] may output the third emission signal in response to the first emission carry signal of the first emission stage EMS[1].

Accordingly, the third emission stage EMS[3] may generate the third emission signal in response to the first emission carry signal of the first emission stage EMS[1] rather than the second emission carry signal of the second emission stage EMS[2], so that the emission clock signals may be set to have a longer period than the clock signals CLKA and CLKB. The period of the emission clock signals may be set longer than the period of the clock signals CLKA and CLKB, so that frequencies of the emission clock signals may be reduced. The frequencies of the emission clock signals may be reduced, so that a power consumption of the display apparatus 1 may be further reduced.

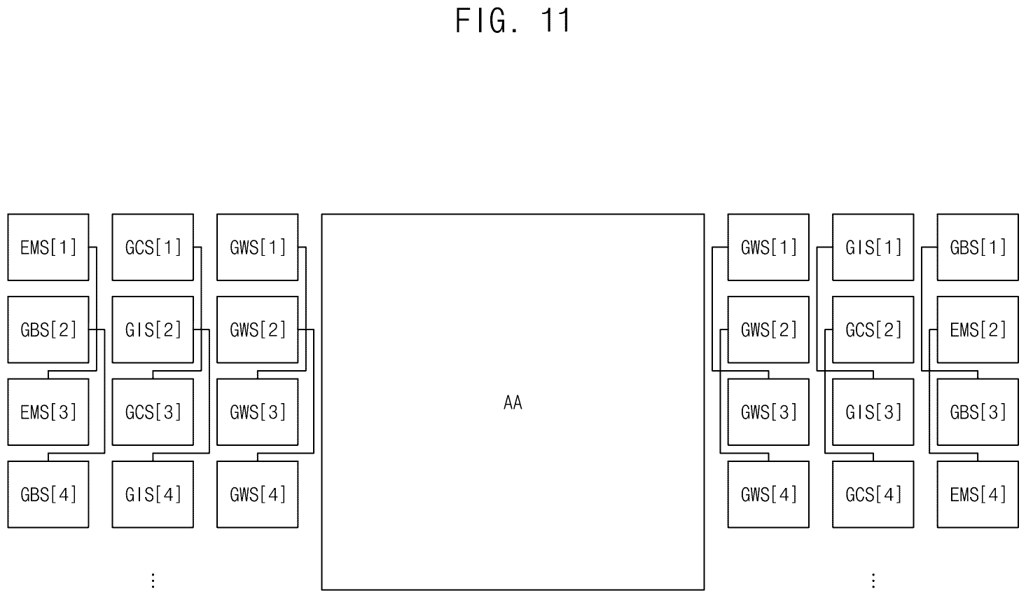

FIG. 11 is a diagram illustrating a location of display panel 100, a gate driver 300 and an emission driver 600 included in a display apparatus 1 of FIG. 1.

Referring to FIG. 1 to FIG. 9 and FIG. 11, the gate driver 300 may include a write gate stage group GWS[1], GWS[2], GWS[3], GWS[4], . . . , a compensation gate stage group GCS[1], GCS[2], GCS[3], GCS[4], . . . , an initialization gate stage group GIS[1], GIS[2], GIS[3], GIS[4], . . . and a bias gate stage group GBS[1], GBS[2], GBS[3], GBS[4], . . . .

The write gate stage group GWS[1], GWS[2], GWS[3], GWS[4], . . . may generate the write gate signal GW applied to the pixel PX. The compensation gate stage group GCS[1], GCS[2], GCS[3], GCS[4], . . . may generate the compensation gate signal GC applied to the pixel PX. The initialization gate stage group GIS[1], GIS[2], GIS[3], GIS[4], . . . may generate the initialization gate signal GI applied to the pixel PX. The bias gate stage group GBS[1], GBS[2], GBS[3], GBS[4], . . . may generate the bias gate signal GB applied to the pixel PX.

The emission driver 600 may include an emission stage group EMS[1], EMS[2], EMS[3], EMS[4], . . . . The emission stage group EMS[1], EMS[2], EMS[3], EMS[4], . . . may generate the emission signal EM applied to pixel PX.

The emission stage group EMS[1], EMS[2], EMS[3], EMS[4], . . . may be alternately located on the first peripheral region PA1 and the second peripheral region PA2. For example, a first emission stage EMS[1] may be located on the first peripheral region PA1. For example, a second emission stage EMS[2] may be located on the second peripheral region PA2. For example, a third emission stage EMS[3] may be located on the first peripheral region PA1. For example, a fourth emission stage EMS[4] may be located on the second peripheral region PA2. The emission stage group EMS[1], EMS[2], EMS[3], EMS[4], . . . may include an emission odd stage group EMS[1], EMS[3], . . . and an emission even stage group EMS[2], EMS[4], . . . . The emission odd stage group EMS[1], EMS[3], . . . may be located on the first side of the display panel 100. The emission odd stage group EMS[1], EMS[3], . . . may be located on the first peripheral region PA1. The emission even stage group EMS[2], EMS[4], . . . may be located on the second side of the display panel 100. The emission even stage group EMS[2], EMS[4], . . . may be located on the second peripheral region PA2.

The bias gate stage group GBS[1], GBS[2], GBS[3], GBS[4], . . . may be alternately located on the first peripheral region PA1 and the second peripheral region PA2. For example, a first bias gate stage GBS[1] may be located on the second peripheral region PA2. For example, a second bias gate stage GBS[2] may be located on the first peripheral region PA1. For example, a third bias gate stage GBS[3] may be located on the second peripheral region PA2. For example, a fourth bias gate stage GBS[4] may be located on the first peripheral region PA1. The bias gate stage group GBS[1], GBS[2], GBS[3], GBS[4], . . . may include a bias gate odd stage group GBS[1], GBS[3], . . . and a bias gate even stage group GBS[2], GBS[4], . . . . The bias gate odd stage group GBS[1], GBS[3], . . . may be located on the second side of the display panel 100. The bias gate odd stage group GBS[1], GBS[3], . . . may be located on the second peripheral region PA2. The bias gate even stage group GBS[2], GBS[4], . . . may be located on the first side of the display panel 100. The bias gate even stage group GBS[2], GBS[4], . . . may be located on the first peripheral region PA1.

The compensation gate stage group GCS[1], GCS[2], GCS[3], GCS[4], . . . may be alternately located on the first peripheral region PA1 and the second peripheral region PA2. For example, a first compensation gate stage GCS[1] may be located on the first peripheral region PA1. For example, a second compensation gate stage GCS[2] may be located on the second peripheral region PA2. For example, a third compensation gate stage GCS[3] may be located on the first peripheral region PA1. For example, a fourth compensation gate stage GCS[4] may be located on the second peripheral region PA2. The compensation gate stage group GCS[1], GCS[2], GCS[3], GCS[4], . . . may include a compensation gate odd stage group GCS[1], GCS[3], . . . and a compensation gate even stage group GCS[2], GCS[4], . . . . The compensation gate odd stage group GCS[1], GCS[3], . . . may be located on the first side of the display panel 100. The compensation gate odd stage group GCS[1], GCS[3], . . . may be located on the first peripheral region PA1. The compensation gate even stage group GCS[2], GCS[4], . . . may be located on the second side of the display panel 100. The compensation gate even stage group GCS[2], GCS[4], . . . may be located on the second peripheral region PA2.

The initialization gate stage group GIS[1], GIS[2], GIS[3], GIS[4], . . . may be alternately located on the first peripheral region PA1 and the second peripheral region PA2. For example, a first initialization gate stage GIS[1] may be located on the second peripheral region PA2. For example, a second initialization gate stage GIS[2] may be located on the first peripheral region PA1. For example, a third initialization gate stage GIS[3] may be located on the second peripheral region PA2. For example, a fourth initialization gate stage GIS[4] may be located on the first peripheral region PA1. The initialization gate stage group GIS[1], GIS[2], GIS[3], GIS[4], . . . may include an initialization gate odd stage group GIS[1], GIS[3], . . . and an initialization gate even stage group GIS[2], GIS[4], . . . . The initialization gate odd stage group GIS[1], GIS[3], . . . may be located on the second side of the display panel 100. The initialization gate odd stage group GIS[1], GIS[3], . . . may be located on the second peripheral region PA2. The initialization gate even stage group GIS[2], GIS[4], . . . may be located on the first side of the display panel 100. The initialization gate even stage group GIS[2], GIS[4], . . . may be located on the first peripheral region PA1.

For example, the emission odd stage group EMS[1], EMS[3], . . . and the bias gate even stage group GBS[2], GBS[4], . . . may be alternately located on the first peripheral region PA1. For example, the emission even stage group EMS[2], EMS[4], . . . and the bias gate odd stage group GBS[1], GBS[3], . . . may be alternately located on the second peripheral region PA2.

The bias gate odd stage group GBS[1], GBS[3], . . . may generate bias odd gate signals based on the right clock signal group CLKAR and CLKBR. The bias gate even stage group GBS[2], GBS[4], . . . may generate bias even gate signals based on the left clock signal group CLKAL and CLKBL. The third bias gate stage GBS[3] may output a third bias gate signal GB[3] in response to a first bias gate carry signal of the first bias gate stage GB[1].

Accordingly, the third bias gate stage GBS[3] may generate the third bias gate signal in response to the first bias gate carry signal of the first bias gate stage GBS[1] rather than the second bias gate carry signal of the second bias gate stage GBS[2], so that the bias gate clock signal may be set to have a longer period than the clock signals CLKA and CLKB. The period of the bias gate clock signals may be set longer than the period of the clock signals CLKA and CLKB, so that frequencies of the bias gate clock signals may be reduced. The frequencies of the bias clock signals may be reduced, so that a power consumption of the display apparatus 1 may be reduced.

Additionally, the emission odd stage group EMS[1], EMS[3], . . . may generate an odd emission signals based on the left emission clock signal group. The even emission stage group EMS[2], EMS[4], . . . may generate the even emission signals based on the right emission clock signal group. The third emission stage EMS[3] may output the third emission signal in response to the first emission carry signal of the first emission stage EMS[1].

Accordingly, the third emission stage EMS[3] may generate the third emission signal in response to the first emission carry signal of the first emission stage EMS[1] rather than the second emission carry signal of the second emission stage EMS[2], so that the emission clock signals may be set to have a longer period than the clock signals CLKA and CLKB. The period of the emission clock signals may be set longer than the period of the clock signals CLKA and CLKB, so that frequencies of the emission clock signals may be reduced. The frequencies of the emission clock signals may be reduced, so that a power consumption of the display apparatus 1 may be further reduced.

Additionally, the compensation gate stage group GCS[1], GCS[2], GCS[3], GCS[4], . . . may be alternately located on the first peripheral region PA1 and the second peripheral region PA2. The initialization gate stage group GIS[1], GIS[2], GIS[3], GIS[4], . . . may be alternately located on the first peripheral region PA1 and the second peripheral region PA2. Accordingly, a compensation gate clock signal and an initialization gate clock signal may be set to have a longer period than the clock signals CLKA and CLKB. The period of the compensation gate clock signal and the initialization gate clock signal may be set longer than the period of the clock signals CLKA and CLKB, so that frequencies of the compensation gate clock signal and the initialization gate clock signal may be reduced. The frequencies of the compensation gate clock signal and the initialization gate clock signal may be reduced, so that a power consumption of the display apparatus 1 may be further reduced.

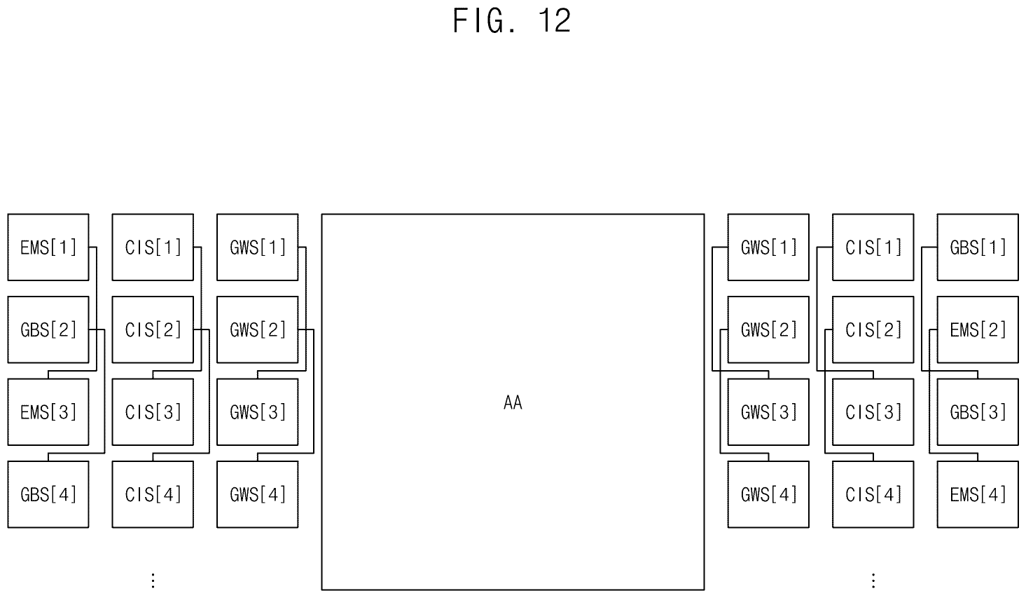

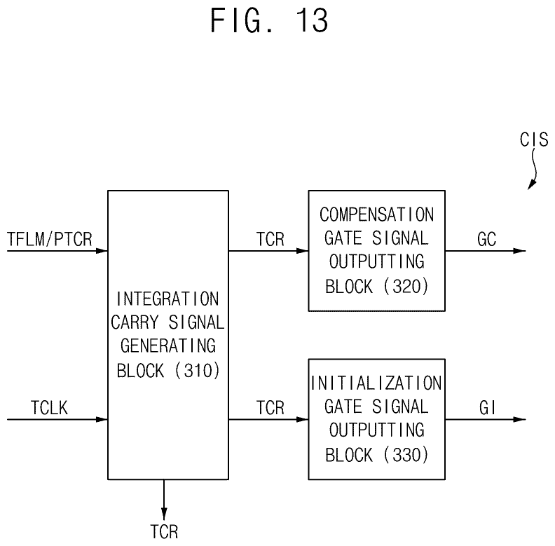

FIG. 12 is a diagram illustrating a location of display panel 100, a gate driver 300 and an emission driver 600 included in a display apparatus 1 of FIG. 1. FIG. 13 is a block diagram illustrating an integration gate stage included in a gate driver of FIG. 12.

Referring to FIG. 1 to FIG. 9, FIG. 12 and FIG. 13, an integration gate stage CIS may include an integration-carry-signal-generating block 310, a compensation-gate-signal-outputting block 320, and an initialization-gate-signal-outputting block 330.

The integration-carry-signal-generating block 310 may generate an integration gate stage carry signal TCR based on an integration start signal TFLM and an integration gate clock signal TCLK. In one or more embodiments, the integration start signal TFLM may be a previous integration gate stage carry signal PTCR. The previous integration gate stage carry signal PTCR may be the integration gate stage carry signal TCR outputted from a previous integration gate stage. The integration-carry-signal-generating block 310 may output the integration gate stage carry signal TCR to a next integration-carry-signal-generating block.

The compensation-gate-signal-outputting block 320 may output the compensation gate signal GC based on the integration gate stage carry signal TCR.

The initialization-gate-signal-outputting block 330 may output the initialization gate signal GI based on the integration gate stage carry signal TCR.

Waveforms of the compensation gate signal GC and the initialization gate signal GI may be substantially similar, and output timings may be different. For example, the output timing of the initialization gate signal GI may be faster than the output timing of the compensation gate signal GC. For example, the output timing of the compensation gate signal GC may be faster than the output timing of the initialization gate signal GI.

The integration gate stage CIS may output the compensation gate signal GC and the initialization gate signal GI. For example, the compensation gate signal GC and the initialization gate signal GI may be generated based on one integration gate stage carry signal TCR. The compensation gate signal GC and the initialization gate signal GI may be generated based on one integration gate stage carry signal TCR, so that an integration of the gate driver 300 may be improved. For example, the gate driver 300 may not include an initialization-gate-carry-signal-generating block for generating the initialization gate carry signal. Accordingly, the integration of the gate driver 300 may be improved.

The gate driver 300 may include a write gate stage group GWS[1], GWS[2], GWS[3], GWS[4], . . . , an integration gate stage group CIS[1], CIS[2], CIS[3], CIS[4], . . . and a bias gate stage group GBS[1], GBS[2], GBS[3], GBS[4], . . . .

The write gate stage group GWS[1], GWS[2], GWS[3], GWS[4], . . . may generate the write gate signal GW applied to the pixel PX. The integration gate stage group CIS[1], CIS[2], CIS[3], CIS[4], . . . may generate the compensation gate signal GC applied to the pixel PX. The integration gate stage group CIS[1], CIS[2], CIS[3], CIS[4], . . . may generate the initialization gate signal GI applied to the pixel PX. The bias gate stage group GBS[1], GBS[2], GBS[3], GBS[4], . . . may generate the bias gate signal GB applied to the pixel PX.

The emission driver 600 may include an emission stage group EMS[1], EMS[2], EMS[3], EMS[4], . . . . The emission stage group EMS[1], EMS[2], EMS[3], EMS[4], . . . may generate the emission signal EM applied to pixel PX.

The emission stage group EMS[1], EMS[2], EMS[3], EMS[4], . . . may be alternately located on the first peripheral region PA1 and the second peripheral region PA2. For example, a first emission stage EMS[1] may be located on the first peripheral region PA1. For example, a second emission stage EMS[2] may be located on the second peripheral region PA2. For example, a third emission stage EMS[3] may be located on the first peripheral region PA1. For example, a fourth emission stage EMS[4] may be located on the second peripheral region PA2. The emission stage group EMS[1], EMS[2], EMS[3], EMS[4], . . . may include an emission odd stage group EMS[1], EMS[3], . . . and an emission even stage group EMS[2], EMS[4], . . . . The emission odd stage group EMS[1], EMS[3], . . . may be located on the first side of the display panel 100. The emission odd stage group EMS[1], EMS[3], . . . may be located on the first peripheral region PA1. The emission even stage group EMS[2], EMS[4], . . . may be located on the second side of the display panel 100. The emission even stage group EMS[2], EMS[4], . . . may be located on the second peripheral region PA2.

The bias gate stage group GBS[1], GBS[2], GBS[3], GBS[4], . . . may be alternately located on the first peripheral region PA1 and the second peripheral region PA2. For example, a first bias gate stage GBS[1] may be located on the second peripheral region PA2. For example, a second bias gate stage GBS[2] may be located on the first peripheral region PA1. For example, a third bias gate stage GBS[3] may be located on the second peripheral region PA2. For example, a fourth bias gate stage GBS[4] may be located on the first peripheral region PA1. The bias gate stage group GBS[1], GBS[2], GBS[3], GBS[4], . . . may include a bias gate odd stage group GBS[1], GBS[3], . . . and a bias gate even stage group GBS[2], GBS[4], . . . . The bias gate odd stage group GBS[1], GBS[3], . . . may be located on the second side of the display panel 100. The bias gate odd stage group GBS[1], GBS[3], . . . may be located on the second peripheral region PA2. The bias gate even stage group GBS[2], GBS[4], . . . may be located on the first side of the display panel 100. The bias gate even stage group GBS[2], GBS[4], . . . may be located on the first peripheral region PA1.

The integration gate stage group CIS[1], CIS[2], CIS[3], CIS[4], . . . may be located on the first side or the second side of the display panel 100. For example, the integration gate stage group CIS[1], CIS[2], CIS[3], CIS[4], . . . may be located on the first peripheral region PA1 or the second peripheral region PA2. The integration gate stage group CIS[1], CIS[2], CIS[3], CIS[4], . . . may be sequentially located on the first side and the second side of the display panel 100.

The bias gate stage group GBS[1], GBS[2], GBS[3], GBS[4], . . . may be alternately located on the first peripheral region PA1 and the second peripheral region PA2. The emission stage group EMS[1], EMS[2], EMS[3], EMS[4], . . . may be alternately located on the first peripheral region PA1 and the second peripheral region PA2. Accordingly, a bias gate clock signal and an emission clock signal may be set to have a longer period than the clock signals CLKA and CLKB. The period of the bias gate clock signal and the emission clock signal may be set longer than the period of the clock signals CLKA and CLKB, so that frequencies of the bias gate clock signal and the emission clock signal may be reduced. The frequencies of the bias gate clock signal and the emission clock signal may be reduced, so that a power consumption of the display apparatus 1 may be further reduced.

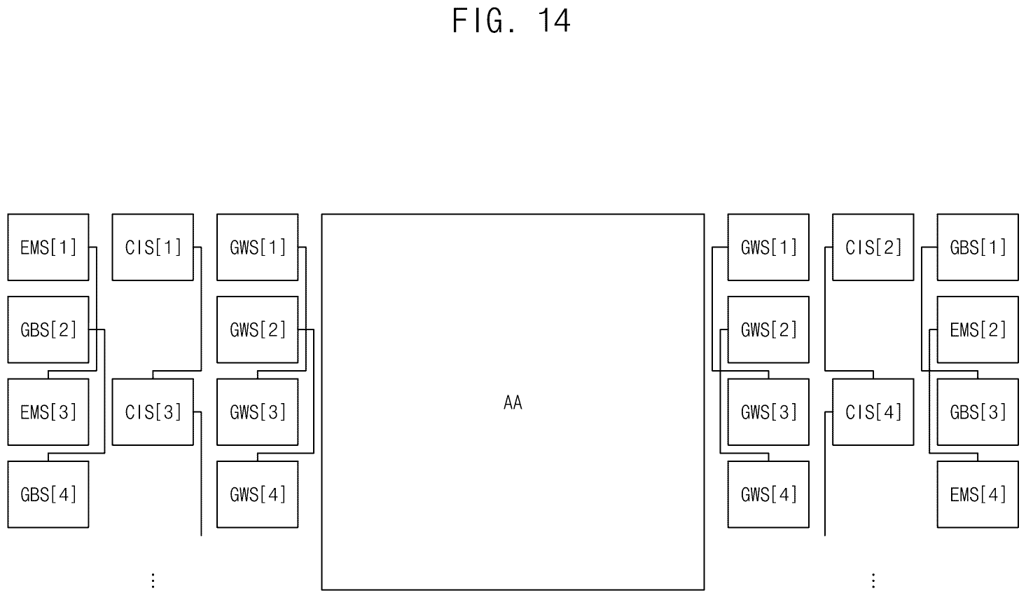

FIG. 14 is a diagram illustrating a location of display panel 100, a gate driver 300 and an emission driver 600 included in a display apparatus 1 of FIG. 1.

Referring to FIG. 1 to FIG. 9, FIG. 13 and FIG. 14, the gate driver 300 may include a write gate stage group GWS[1], GWS[2], GWS[3], GWS[4], . . . , an integration gate stage group CIS[1], CIS[2], CIS[3], CIS[4], . . . and a bias gate stage group GBS[1], GBS[2], GBS[3], GBS[4], . . . .

The write gate stage group GWS[1], GWS[2], GWS[3], GWS[4], . . . may generate the write gate signal GW applied to the pixel PX. The integration gate stage group CIS[1], CIS[2], CIS[3], CIS[4], . . . may generate the compensation gate signal GC applied to the pixel PX. The integration gate stage group CIS[1], CIS[2], CIS[3], CIS[4], . . . may generate the initialization gate signal GI applied to the pixel PX. The bias gate stage group GBS[1], GBS[2], GBS[3], GBS[4], . . . may generate the bias gate signal GB applied to the pixel PX.

The emission driver 600 may include an emission stage group EMS[1], EMS[2], EMS[3], EMS[4], . . . . The emission stage group EMS[1], EMS[2], EMS[3], EMS[4], . . . may generate the emission signal EM applied to pixel PX.

The emission stage group EMS[1], EMS[2], EMS[3], EMS[4], . . . may be alternately located on the first peripheral region PA1 and the second peripheral region PA2. For example, a first emission stage EMS[1] may be located on the first peripheral region PA1. For example, a second emission stage EMS[2] may be located on the second peripheral region PA2. For example, a third emission stage EMS[3] may be located on the first peripheral region PA1. For example, a fourth emission stage EMS[4] may be located on the second peripheral region PA2. The emission stage group EMS[1], EMS[2], EMS[3], EMS[4], . . . may include an emission odd stage group EMS[1], EMS[3], . . . and an emission even stage group EMS[2], EMS[4], . . . . The emission odd stage group EMS[1], EMS[3], . . . may be located on the first side of the display panel 100. The emission odd stage group EMS[1], EMS[3], . . . may be located on the first peripheral region PA1. The emission even stage group EMS[2], EMS[4], . . . may be located on the second side of the display panel 100. The emission even stage group EMS[2], EMS[4], . . . may be located on the second peripheral region PA2.

The bias gate stage group GBS[1], GBS[2], GBS[3], GBS[4], . . . may be alternately located on the first peripheral region PA1 and the second peripheral region PA2. For example, a first bias gate stage GBS[1] may be located on the second peripheral region PA2. For example, a second bias gate stage GBS[2] may be located on the first peripheral region PA1. For example, a third bias gate stage GBS[3] may be located on the second peripheral region PA2. For example, a fourth bias gate stage GBS[4] may be located on the first peripheral region PA1. The bias gate stage group GBS[1], GBS[2], GBS[3], GBS[4], . . . may include a bias gate odd stage group GBS[1], GBS[3], . . . and a bias gate even stage group GBS[2], GBS[4], . . . . The bias gate odd stage group GBS[1], GBS[3], . . . may be located on the second side of the display panel 100. The bias gate odd stage group GBS[1], GBS[3], . . . may be located on the second peripheral region PA2. The bias gate even stage group GBS[2], GBS[4], . . . may be located on the first side of the display panel 100. The bias gate even stage group GBS[2], GBS[4], . . . may be located on the first peripheral region PA1.

For example, the emission odd stage group EMS[1], EMS[3], . . . and the bias gate even stage group GBS[2], GBS[4], . . . may be alternately located on the first peripheral region PA1. For example, the emission even stage group EMS[2], EMS[4], . . . and the bias gate odd stage group GBS[1], GBS[3], . . . may be alternately located on the second peripheral region PA2.

The integration gate stage group CIS[1], CIS[2], CIS[3], CIS[4], . . . may be alternately located on the first peripheral region PA1 and the second peripheral region PA2. For example, a first integration gate stage CIS[1] may be located on the first peripheral region PA1. For example, a second integration gate stage CIS[2] may be located on the second peripheral region PA2. For example, a third integration gate stage CIS[3] may be located on the first peripheral region PA1. For example, a fourth integration gate stage CIS[4] may be located on the second peripheral region PA2. The integration gate stage group CIS[1], CIS[2], CIS[3], CIS[4], . . . may include an integration gate odd stage group CIS[1], CIS[3], . . . and an integration gate even stage group CIS[2], CIS[4], . . . . The integration gate odd stage group CIS[1], CIS[3], . . . may be located on the first side of the display panel 100. The integration gate odd stage group CIS[1], CIS[3], . . . may be located on the first peripheral region PA1. The integration gate even stage group CIS[2], CIS[4], . . . may be located on the second side of the display panel 100. The integration gate even stage group CIS[2], CIS[4], . . . may be located on the second peripheral region PA2.

The bias gate stage group GBS[1], GBS[2], GBS[3], GBS[4], . . . may be alternately located on the first peripheral region PA1 and the second peripheral region PA2. The emission stage group EMS[1], EMS[2], EMS[3], EMS[4], . . . may be alternately located on the first peripheral region PA1 and the second peripheral region PA2. The integration gate stage group CIS[1], CIS[2], CIS[3], CIS[4], . . . may be alternately located on the first peripheral region PA1 and the second peripheral region PA2. Accordingly, a bias gate clock signal, an emission clock signal, and an integration clock signal may be set to have a longer period than the clock signals CLKA and CLKB. The period of the bias gate clock signal, the emission clock signal, and the integration clock signal may be set longer than the period of the clock signals CLKA and CLKB, so that frequencies of the bias gate clock signal, the emission clock signal, and the integration clock signal may be reduced. The frequencies of the bias gate clock signal, the emission clock signal, and the integration clock signal may be reduced, so that a power consumption of the display apparatus 1 may be further reduced.

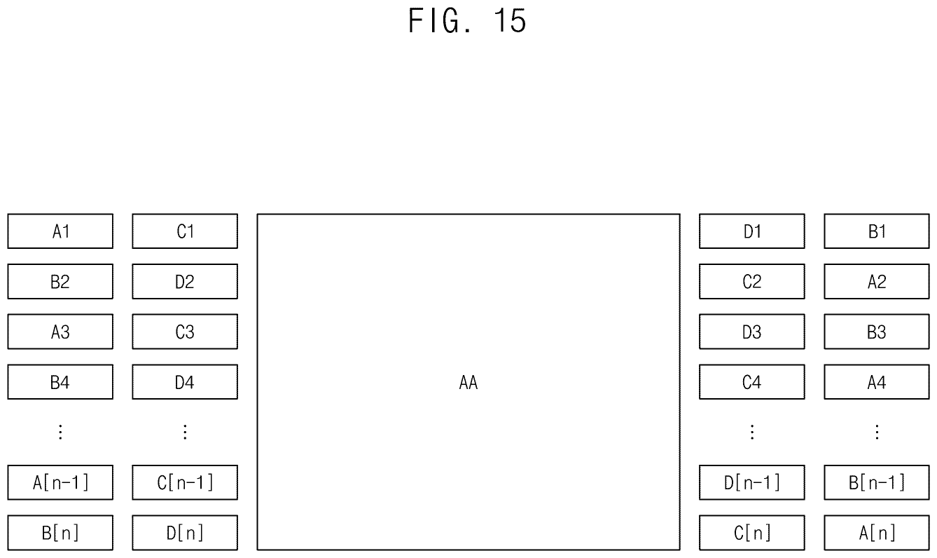

FIG. 15 is a block diagram illustrating a location of stages of a gate driver 300 of FIG. 3.

Referring to FIG. 15, the gate driver 300 is substantially similar to that in FIG. 4 except that the gate driver 300 may include a first gate stage group A1, A2, A3, A4 to A[n−1], and A[n] for generating first gate signals, a second gate stage group B1, B2, B3, B4 to B[n−1], and B[n] for generating second gate signals, a third gate stage group C1, C2, C3, C4 to C[n−1], and C[n] for generating third gate signals, and a fourth gate stage group D1, D2, D3, D4 to D[n−1], and D[n] for generating fourth gate signals, so that the same reference numerals will be used and any repetitive explanation concerning the above elements will be omitted.

The third gate stage group C1, C2, C3, C4 to C[n−1], and C[n] may include a third gate odd stage group C1, C3 to C[n−1] and a third gate even stage group C2, C4 to C[n]. The fourth gate stage group D1, D2, D3, D4 to D[n−1], and D[n] may include a fourth gate odd stage group D1, D3 to D[n−1] and a fourth gate even stage group D2, D4 to D[n]. The third gate odd stage group C1, C3 to C[n−1] and fourth gate even stage group D2, D4 to D[n] may be located on the first side of the display panel 100. The third gate odd stage group C1, C3 to C[n−1] and fourth gate even stage group D2, D4 to D[n] may be located on the first peripheral region PA1. The third gate even stage group C2, C4 to C[n] and fourth gate odd stage group D1, D3 to D[n−1] may be located on the second side of the display panel 100. The third gate even stage group C2, C4 to C[n] and fourth gate odd stage group D1, D3 to D[n−1] may be located on the second peripheral region PA2.

The third gate stage group C1, C2, C3, C4 to C[n−1], and C[n] may be alternately located on the first peripheral region PA1 and the second peripheral region PA2. The fourth gate stage group D1, D2, D3, D4 to D[n−1], and D[n] may be alternately located on the first peripheral region PA1 and the second peripheral region PA2.

Third gate clock signals and fourth gate clock signal may be set to have a longer period than the clock signals CLKA and CLKB. The period of the third gate clock signals and the fourth gate clock signal may be set longer than the period of the clock signals CLKA and CLKB, so that frequencies of the third gate clock signals and the fourth gate clock signal may be reduced. The frequencies of the third gate clock signals and the fourth gate clock signal may be reduced, so that a power consumption of the display apparatus 1 may be further reduced.

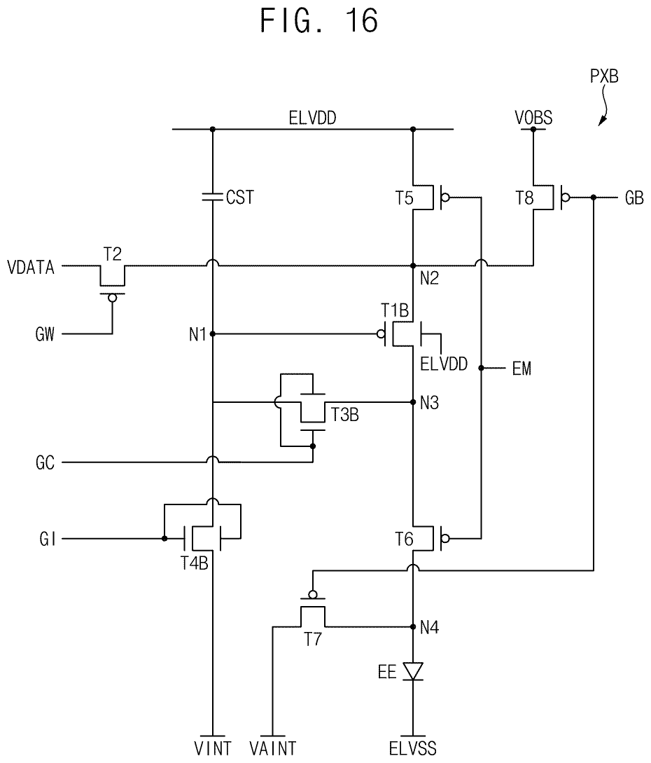

FIG. 16 is a circuit diagram illustrating a pixel PX included in a display apparatus 1 of FIG. 1.

Referring to FIG. 16, a pixel PXB may include a first transistor T1B, the second transistor T2, a third transistor T3B, a fourth transistor T4B, the fifth transistor T5, the sixth transistor T6, the seventh transistor T7 and the eighth transistor T8.

The pixel PXB is substantially similar to the pixel PXA except that the first transistor T1B includes a second control electrode, the third transistor T3B is an N-type transistor, the fourth transistor T4B is an N-type transistor, and the pixel PXB further includes the eighth transistor T8B, so that the same reference numerals will be used, and any repetitive explanation concerning the above elements will be omitted.

The first transistor T1B may include a first control electrode connected to the first node N1, a second control electrode for receiving the high power voltage ELVDD, a first electrode connected to the second node N2, and a second electrode connected to the third node N3. The second control electrode of the first transistor T1B may receive the high power voltage ELVDD, so that a driving stability of the first transistor T1B may be improved.

The third transistor T3B may include a first control electrode for receiving the compensation gate signal GC, a second control electrode for receiving the compensation gate signal GC, a first electrode connected to the third node N3, and a second electrode connected to the first node N1. The second control electrode of the third transistor T3B may receive the compensation gate signal GC, so that a driving stability of the third transistor T3B may be improved.

The fourth transistor T4B may include a first control electrode for receiving the initialization gate signal GI, a second control electrode for receiving the initialization gate signal GI, a first electrode for receiving the initialization voltage VINT, and a second electrode connected to the first node N1. The second control electrode of the fourth transistor T4B may receive the initialization gate signal GI, so that a driving stability of the fourth transistor T4B may be improved.

The eighth transistor T8 may include a control electrode for receiving the bias gate signal GB, a first electrode for receiving a bias voltage VOBS, and a second electrode connected to the second node N2. The eighth transistor T8 may apply the bias voltage VOBS to the first node N1 in response to the bias gate signal GB.

The third transistor T3B and the fourth transistor T4B may be N-type transistors. The third transistor T3B and the fourth transistor T4B may be N-type transistors, so that a leakage current applied to the first node N1 may be reduced. Additionally, the third transistor T3B and the fourth transistor T4B may be N-type transistors, so that a power consumption may be reduced.

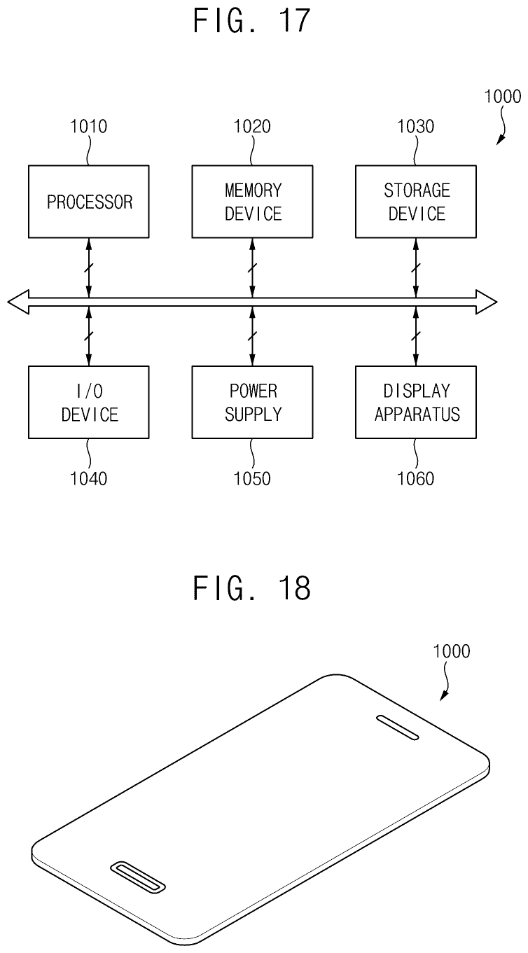

FIG. 17 is a block diagram illustrating an electronic apparatus 1000 according to one or more embodiments of the present disclosure. FIG. 18 is a diagram illustrating an example in which the electronic apparatus of FIG. 17 is implemented as a smart phone.

Referring to FIG. 17, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. Additionally, the electronic apparatus 1000 may further include a plurality of ports for communicating with a video card, a sound card, a memory card, a universal serial bus (USB) device, other electronic apparatus, etc.

In one or more embodiments, as illustrated in FIG. 18, the electronic apparatus 1000 may be implemented as a smart phone. However, the electronic apparatus 1000 is not limited thereto. For example, the electronic apparatus 1000 may be implemented as a cellular phone, a video phone, a smart pad, a smart watch, a tablet PC, a car navigation system, a computer monitor, a laptop, a head-mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc.

Further, the processor 1010 may be coupled to an extended bus such as a peripheral component interconnection (PCI) bus.

The processor 1010 may output the input image data IMG, an app-on signal, and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

Referring to FIG. 18, the electronic apparatus of the present disclosure is shown implemented as a smartphone, but the present disclosure is not limited thereto. The electronic apparatus may be a television, a monitor, a laptop computer, or a tablet. Additionally, the electronic apparatus may be a car.

The display apparatus according to the embodiments may be applied to a display apparatus included in a computer, a notebook, a mobile phone, a smart phone, a smart pad, a PMP, a PDA, an MP3 player, or the like.

The foregoing is illustrative of the present disclosure, and is not to be construed as limiting thereof. Although a few embodiments of the present disclosure have been described, those skilled in the art will readily appreciate that many modifications are possible in the embodiments without materially departing from the aspects of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. A display apparatus comprising:
a display panel comprising a pixel;
a gate driver configured to output gate signals to the display panel, and comprising:
a first gate stage group for generating a first gate signals, and comprising a first gate odd stage group on a first side of the display panel, and a first gate even stage group on a second side of the display panel; and
a second gate stage group for generating a second gate signals, and comprising a second gate odd stage group on the second side, and a second gate even stage group on the first side; and
a data driver configured to apply a data voltage to the display panel.

2. The display apparatus of claim 1, wherein the display panel further comprises an odd pixel-row connected to the first gate odd stage group and the second gate odd stage group, and an even pixel-row connected to the first gate even stage group and the second gate even stage group.

3. The display apparatus of claim 1, wherein the first gate stage group comprises a first-first gate stage, a first-second gate stage, a first-third gate stage, and a first-fourth gate stage, and
wherein the first-third gate stage is configured to receive a first-first gate carry signal of the first-first gate stage, and the first-fourth gate stage is configured to receive a first-second gate carry signal of the first-second gate stage.

4. The display apparatus of claim 3, wherein the second gate stage group comprises a second-first gate stage, a second-second gate stage, a second-third gate stage and a second-fourth gate stage, and
wherein the second-third gate stage is configured to receive a second-first gate carry signal of the second-first gate stage, and the second-fourth gate stage is configured to receive a second-second gate carry signal of the second-second gate stage.

5. The display apparatus of claim 1, further comprising an emission driver configured to output an emission signal to the display panel, and comprising an emission stage group for generating the emission signal, the emission stage group comprising an emission odd stage group on the first side, and an emission even stage group on the second side.

6. The display apparatus of claim 5, wherein the emission stage group comprises a first emission stage, a second emission stage, a third emission stage configured to receive a first emission carry signal of the first emission stage, and a fourth emission stage configured to receive a second emission carry signal of the second emission stage.

7. The display apparatus of claim 1, further comprising a left side clock signal line group on the first side, and a right side clock signal line group on the second side.

8. The display apparatus of claim 1, wherein the gate driver further comprises a third gate stage group for generating third gate signals on the first side, and a fourth gate stage group for generating fourth gate signals on the second side.

9. The display apparatus of claim 1, wherein the gate driver further comprises:
a third gate stage group for generating third gate signals, and comprising a third gate odd stage group on the first side, and a third gate even stage group on the second side; and
a fourth gate stage group for generating fourth gate signals, and comprising fourth gate odd stage group on the second side, and a fourth gate even stage group on the first side.

10. The display apparatus of claim 1, wherein the gate driver further comprises an integration gate stage group,
wherein at least one integration gate stage of the integration gate stage group comprises:
an integration-carry-signal-generating block configured to generate an integration gate stage carry signal in response to a previous integration gate stage carry signal;
a third-gate-signal-generating block configured to generate a third gate signal in response to the integration gate stage carry signal; and
a fourth-gate-signal-generating block configured to generate a fourth gate signal in response to the integration gate stage carry signal.

11. The display apparatus of claim 10, wherein the integration gate stage group is on the first side.

12. The display apparatus of claim 10, wherein the integration gate stage group comprises an integration gate odd stage group on the first side, and an integration gate even stage group on the second side.

13. The display apparatus of claim 12, wherein the integration gate odd stage group comprises a third integration gate stage and a first integration gate stage configured to receive the previous integration gate stage carry signal of the third integration gate stage as the integration gate stage carry signal, and
wherein the integration gate even stage group comprises a fourth integration gate stage, and a second integration gate stage configured to receive the previous integration gate stage carry signal of the fourth integration gate stage as the integration gate stage carry signal.

14. A display apparatus comprising:
a display panel comprising a pixel;
a gate driver configured to output a write gate signal and a bias gate signal to the display panel, and comprising a bias gate stage group for generating the bias gate signal, the bias gate stage group comprising a bias gate odd stage group on a first side of the display panel, and a bias gate even stage group on a second side of the display panel;
an emission driver configured to output an emission signal to the display panel, and comprising an emission stage group for generating the emission signal, the emission stage group comprising an emission odd stage group on the second side, and an emission even stage group on the first side; and
a data driver configured to apply a data voltage to the display panel.

15. The display apparatus of claim 14, wherein the display panel comprises an odd pixel-row connected to the bias gate odd stage group and the emission odd stage group, and an even pixel-row connected to the bias gate even stage group and the emission even stage group.

16. The display apparatus of claim 14, wherein the bias gate stage group comprises a first bias gate stage, a second bias gate stage, a third bias gate stage configured to receive a first bias gate carry signal of the first bias gate stage, and a fourth bias gate stage configured to receive a second bias gate carry signal of the second bias gate stage.

17. The display apparatus of claim 16, wherein the emission stage group comprises, a third first emission stage, a fourth first emission stage, a first emission stage configured to apply a first emission carry signal to the third first emission stage, a second emission stage configured to apply a second emission carry signal to the fourth first emission stage.

18. The display apparatus of claim 16, wherein the pixel comprises:
a driving transistor comprising a control electrode connected to a first node, a first electrode connected to a second node, and a second electrode connected to a third node;
a writing transistor configured to apply the data voltage to the second node in response to the write gate signal;
a first emission transistor configured to connect the third node and a fourth node in response to the emission signal;
a light-emitting element initialization transistor configured to apply a light-emitting element initialization voltage to the fourth node in response to the bias gate signal; and
a light-emitting element comprising a first electrode connected to the fourth node, and a second electrode for receiving a low power voltage.

19. The display apparatus of claim 18, wherein the gate driver is configured to output a compensation gate signal and an initialization gate signal,
wherein the pixel further comprises:
a compensation transistor configured to connect the first node and the third node in response to the compensation gate signal; and
an initialization transistor configured to apply an initialization voltage to the first node in response to the initialization gate signal, and
wherein the gate driver further comprises:
a compensation gate stage group for generating the compensation gate signal, and comprising a compensation gate odd stage group on the first side and a compensation gate even stage group on the second side; and
an initialization gate stage group for generating the initialization gate signal, and comprising an initialization gate odd stage group on the second side and an initialization gate even stage group on the first side.

20. An electronic apparatus comprising:
a display panel comprising a pixel;
a gate driver configured to output gate signals to the display panel, and comprising:
a first gate stage group for generating a first gate signals, and comprising a first gate odd stage group on a first side of the display panel, and a first gate even stage group on a second side of the display panel; and
a second gate stage group for generating a second gate signals, and comprising a second gate odd stage group on the second side, and a second gate even stage group on the first side; and
a data driver configured to apply a data voltage to the display panel.
